(19) United States
(12) Patent Application Publication
(10) Pub. No.: US 2005/0153170 A1
(43) Pub. Date: Jul. 14, 2005

(54) Magnetic tape and magnetic tape cartridge

(75) Inventors: Tetsutaro Inoue, Ikeda-shi (JP); Tsugihiro Doi, Ibaraki-shi (JP); Mikio Kishimoto, Moriya-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka 567-8567 (JP)

(21) Appl. No.: 10/507,134

(22) PCT Filed: Jul. 16, 2003
(86) PCT No.: PCT/JP03/09004

(30) Foreign Application Priority Data
Jul. 18, 2002 (JP) 2002-210313

(51) Int. Cl. B32B 5/16; G11B 5/64

(52) U.S. Cl. 428/694 TB; 428/328; 428/329

(57) ABSTRACT

There is provided a magnetic tape comprising a non-magnetic support, and a primer layer and a magnetic layer both formed on a surface of the non-magnetic support, and a backcoat layer formed on the other surface of the non-magnetic support, wherein the magnetic layer contains magnetic powder which comprises needle-like iron-based magnetic particles, and has a thickness of 0.09 μm or less; and the primer layer contains non-magnetic powder which comprises plate-like non-magnetic oxide particles with an average particle size of 10 to 100 nm. Further, the thermal expansion coefficient of the magnetic layer in the tape widthwise direction is (0 to 8)×10⁻⁶/° C., and the humidity expansion coefficient of the magnetic layer in the tape widthwise direction is (0 to 10)×10⁻⁶/% RH; and the amount of edge weave which is formed on either of the edges of the tape serving as the side of reference for the feeding of the tape is 0.8 μm or less. This magnetic tape is excellent in performance for recording/reproducing signals with short wavelengths and hardly causes a decrease in reproducing output due to off-track.

### FIELD OF THE INVENTION

The present invention relates to a magnetic tape which has a large recording capacity, and permits a high access speed and a high transfer speed, and to a magnetic tape cartridge comprising the same. In particular, the present invention relates to a magnetic tape on which magnetic signals or optical signals for servo tracking are recorded and from which magnetically recorded signals are reproduced with reproducing heads comprising magnetoresistance elements (hereinafter referred to as “MR heads”), and to a single reel type magnetic tape cartridge comprising the same, suitable for use in data-backup.

### BACKGROUND ART

Magnetic tapes have found various applications in audio tapes, videotapes, computer tapes, etc. In particular, in the field of magnetic tapes for data-backup (or backup tapes), tapes having memory capacities of 100 GB or more per reel are commercialized in association with increased capacities of hard discs for back-up. Therefore, it is indispensable to increase the capacity of this type of tape for data-backup, so as to meet the demand for a hard disc having a far larger memory capacity. It is also necessary to increase the feeding speed of tape and a relative speed between the tape and heads in order to quicken the access speed and the transfer speed.

To increase the capacity of tape for data-backup per one reel, it is necessary to increase the length of tape per reel by decreasing the total thickness of the tape, to reduce the thickness demagnetization so as to shorten the recording wavelength by forming a magnetic layer with a thickness as very thin as 0.09 μm or less, and to increase the recording density in the tape-widthwise direction by narrowing the widths of the recording tracks.

When the thickness of the magnetic layer is reduced to 0.09 μm or less, it is difficult to obtain a coating layer with an uniform thickness, and the durability of the tape tend to lower. Therefore, it is preferable that at least one primer layer is provided between a non-magnetic support and the magnetic layer, so as to avoid such problems. When the recording wavelength is shortened, the influence of spacing between the magnetic layer and the magnetic heads becomes serious. Thus, if the magnetic layer has a coarse surface, the output markedly decreases due to the spacing loss, so that the error rate increases. Further, it is desirable to smoothen the surface of the magnetic layer and simultaneously pay attention to the surface roughness and shape of the backcoat layer so as not to transfer the coarseness of the backcoat layer to the magnetic layer.

When the thickness of the magnetic layer is so thin as 0.09 μm or less, the influence of the primer layer laid under the magnetic layer (i.e., between the non-magnetic support and the magnetic layer) becomes larger. Therefore, it is necessary to smoothen the interface between the primer layer and the magnetic layer as much as possible, so as to smoothen the magnetic layer. In addition, such a primer layer that can facilitate the orientation of magnetic powder is demanded under the circumstance where it becomes difficult to orient magnetic powder in the lengthwise direction as the particles of magnetic powder becomes smaller and smaller and as the coating layer becomes thinner and thinner.

In general, a coating type magnetic tape is produced by forming a non-magnetic primer layer which contains non-magnetic powder comprising needle-like or granular particles, on a non-magnetic support, and forming a magnetic layer which contains magnetic powder comprising needle-like particles, on the surface of the primer layer. In the meantime, when the magnetic layer with a thickness of as thin as 0.09 μm or less is formed thereon, variation in thickness at the interface between the non-magnetic primer layer and the magnetic layer gives an influence on the magnetic layer. As a result, the magnetic layer has a coarse surface and a non-uniform thickness, or the squareness decreases. Further, the needle-like magnetic particles which have not been oriented in parallel with the coating layer penetrate the non-magnetic primer layer in the course of the drying step or the calnedering step, so that the interface between the magnetic layer and the primer layer becomes more variable, which results in increased noises.

When a magnetic layer with a thickness of so thin as 0.09 μm or less is formed and where the recording density is increased by narrowing the widths of recording tracks, leakage magnetic fluxes from the magnetic tape becomes smaller. Therefore, it is preferable to use, as reproducing heads, MR heads which comprise magnetoresistance elements capable of obtaining high outputs even if magnetic fluxes are very small.

Examples of the magnetic recording media which can correspond to MR heads are disclosed in JP-A-11-238225, JP-A-2000-40217 and JP-A-2000-40218. In these magnetic recording media, skewness of outputs from the MR heads is prevented by controlling the magnetic fluxes from the magnetic recording medium (a product of a residual magnetic flux density and the thickness of the medium) to a specific value or less, or the thermal asperity of the MR heads is reduced by lessening the dents on the surface of the magnetic layers to a specific value or less.

When the width of the recording tracks is decreased, the reproduction output lowers due to off-track. To avoid such a problem, a track servo system is employed in the tape-feeding system. As types of such track servo systems, there are an optical servo system (JP-A-11-213384, JP-A-11-339254 and JP-A-2000-293836) and a magnetic servo system. In either of these systems, it is desirable that track servo is performed on a magnetic tape which is drawn out from a magnetic tape cartridge (which may be also called a cassette tape) of single reel type which comprises only one reel for winding the magnetic tape, in a box-shaped casing body. The reason for using a single reel type cartridge is that, when the tape-running speed is increased to, for example, 2.5 m/second or higher, a tape can be more stably run in the single reel type cartridge, as compared with a two-reel type cartridge which has two reels for drawing out the tape and for winding the same. The two-reel type cartridge has other problems in that the dimensions of the cartridge become larger and that the memory capacity per volume becomes smaller.

As mentioned above, there are two types of track servo systems, i.e., the magnetic servo system and the optical servo system. In the former track servo system, servo track bands as shown in FIG. 9 are formed on a magnetic layer by magnetic recording, and servo tracking is performed by magnetically reading such servo track bands. In the latter optical servo system, servo track bands each consisting of an array of pits are formed on a backcoat layer by laser irradiation or the like, and servo tracking is performed by optically reading such servo track bands. Other than these systems, there is such magnetic serve system in which magnetic servo signals are also recorded on a magnetized backcoat layer (cf. JP-A-11-126327). Further, in other optical servo system, optical servo signals are recorded on a backcoat layer, using a material capable of absorbing light or the like (cf. JP-A-11-126328).

Then, the principle of the track servo system is simply described by way of the former magnetic servo system.

As shown in FIG. 9, in the magnetic tape (3) for the magnetic servo system, servo bands (200) for track serve which extend along the lengthwise direction of the tape and are spaced from one another at about 2.8 mm intervals, and data tracks (300) for recording data are formed on the magnetic layer. Each servo band (200) consists of a plurality of servo signal-recording sections (201) on which the respective servo track numbers are magnetically recorded. A magnetic head array (80) (see FIG. 7), which records and reproduces data on the magnetic tape (3), consists of a pair of MR heads for servo track (forward running and backward running) at both ends, and for example, 8×1 pairs of recording/reproducing heads (in which the recording heads are magnetic induction type heads and the reproducing heads are MR heads) which are arranged between the MR heads for servo tracking at both ends. In response to a signal from the MR head for servo track which has read a servo signal, the entire magnetic head array moves interlocking with each other, so that the recording/reproducing heads move in the widthwise direction of the tape to reach the data tracks (300) (for example, in case of the magnetic head array on which 8×1 pairs of recording/reproducing heads are arranged, 16 data tracks are formed corresponding to a pair of serve tracks).

In this stage, as shown in FIG. 8, the magnetic tape (3) runs in such a state that one of both tape edges (3a) extending along the lengthwise direction is regulated in its tape widthwise position by the inner surface of a flange of a guide roller (70) provided in a magnetically recording/reproducing unit (a tape-driving unit). As seen in a partially enlarged diagram shown in FIG. 4, the edge (3a) of the magnetic tape (3) generally has corrugated unevenness called edge weave or edge wave (unevenness formed by the waving of the widthwise edge of the tape alongside the tape lengthwise direction). Therefore, the magnetic tape (3), even though running alongside the inner surface of the flange as the reference for the tape running, very slightly fluctuates in its position in the widthwise direction. However, this problem is solved by employing the above-mentioned servo system: that is, even if the position of the magnetic tape very slightly fluctuates in the widthwise direction, the entire magnetic head array moves in the tape widthwise direction in association with such a fluctuation, so that the recording/reproducing heads can always reach the correct data tracks.

In this case, if the tape has a high edge weave a having a frequency [(V/f): s⁻¹=Hz] of 50 Hz or more, particularly 200 Hz or more, provided that V is a tape-running speed and f is a cycle of the edge weave, the magnetic head array cannot follow the tracks. Thus, the magnetic head array dislocates from the tracks (i.e., off-track). However, such off-track is not so serious, when the recording track width is as wide as 30 μm or more, and where the difference between the recording track width and the reproducing track width [(recording track width)−(reproducing track width)] exceeds 16 μm, for example, when the recording track width is about 80 μm, and the reproducing track width, about 50 μm. This is because, when the recording track width is as wide as 30 μm or more and when the above difference exceeds 16 μm, the recording track width is sufficiently wider than the reproducing track width, so that the reproducing heads can run on the recording tracks, even if off-track of several micrometers occurs. Thus, this off-track does not leads to a decrease in output.

In another case, when a temperature or a humidity changes, off-track tends to occur, because the magnetic tape expands or contracts in the tape-widthwise direction in association with such a change. However, off-track in association with a change in temperature and/or humidity is not so serious for the same reason as above, when the recording track width is as wide as 30 μm or more, and where the above difference exceeds 16 μm. In this regard, although the expansion of the magnetic tape in the lengthwise direction due to a change in temperature and/or humidity may cause a change in the recording wavelength or the like, correction of circuits is possible for such a change.

As a result of further investigation, it is found that such a change in temperature and/or humidity does not induce a serious problem under specified conditions, even if the recording track width is as narrow as 30 μm or less, and the above difference is as small as 16 μm or less. That is, a decrease in reproduction output due to off-track hardly causes a problem under the following conditions (a) or (b): (a) off-tack due to a change in temperature and/or humidity is small, although off-track due to the edge weave is large; and (b) off-track due to the edge weave is small, although off-track due to a change in temperature and/or humidity is large.

As described above, to improve the recording density of a magnetic tape and to effectively function servo controlling, the magnetic layer of the magnetic tape should be formed with a thin thickness, and have a smooth surface and an uniform thickness; magnetic powder should comprise very fine particles which can surely be oriented in the lengthwise direction; the magnetic tape should have dimensional stability in the widthwise direction against a change in temperature/humidity; and the amount of the edge weave should be reduced.

However, as a result of more intensive investigation, it was revealed that a decrease in reproduction output due to off-track tends to occur, even though the amount of the edge weave and the coefficient of thermal and/or humidity expansion are each negligibly small, when the recording track width is so narrow as less than 24 μm and the above difference of [(recording track width)−(reproducing track width)] is so small as less than 12 μm. While there is a fluctuation of several micrometers in position between the recording heads and the reproducing heads in the apparatus, this fluctuation becomes at least two times larger under the worst combination of the conditions. The off-track due to the edge weave together with the off-track due to a change in temperature/humidity further give adverse influence, which results in a decrease in reproduction output. This phenomenon is remarkable when the difference of [(recording track width)−(reproducing track width)] is 10 μm or less.

When the width of the recording track is further reduced to 21 μm or less, a decrease in reproduction output due to off-track occurs in spite of about 2 μm of edge weave, which hitherto has raised no problem in the conventional recording tracks. This is because, when the reproducing track width should be equal to a conventional one in order to ensure a reproduction output, the off-track margin becomes narrower. Further, when the recording track width is as narrow as 21 μm or less, it is confirmed that not only the absolute value of edge weave but also the cycle of the edge weave and the tape running speed have a complicated relationship with the off-track.

To apply the servo system to a magnetic tape having recording tracks with widths as narrow as 21 μm or less, a relationship of the cycle and the amount of edge weave, the recording track width, the reproducing track width and the tape running speed, with the head followability is carefully examined. As a result, the following are revealed: a position error signal (or PES, i.e. a value indicating a fluctuation in positional dislocation; the value of a standard deviation 1a) becomes higher, resulting in a tracking error, if the values of [α/(Tw−Tr)] and [α/(Tw−Tr)]×(V/f) exceed 0.07 and 13.3, respectively, wherein a is an amount of the edge weave having a cycle of f (displacement in the tape widthwise direction of the tape edge (the direction Y-Y′ on FIG. 4)); V [mm/second] is a tape running speed; Tw [μm] is a recording track width; and Tr [μm] is a reproducing track width. This problem is considered to arise as follows. Since the magnetic head array as a whole has large mass, the magnetic head array cannot move following the motion of the magnetic tape in the widthwise direction, when the values of [α/(Tw−Tr)] and [α/(Tw−Tr)×(V/f)] exceed 0.07 and 13.3, respectively. As a result, a position error signal or PES becomes higher. When the off-track margin is small, the off-track becomes larger to cause a such a tracking error. It is ideal that the above two values are zero.

This is a problem which newly arises particularly when the recording track width is set at as narrow as 21 μm or less, and which is not so serious when the recording track width is 21 μm or more (particularly 24 μm or more). When the recording track width exceeds 21 μm, a decrease in reproducing output due to off-track hardly occurs, even if PES is high due to dull motion of the magnetic head array. This is because the recording track width is sufficiently wider than the reproducing track width to provide a wide off-track margin (for example, when the recording track width is about 28 μm and the reproducing track width, about 12 μm, or where the recording track width is about 24 μm and the reproducing track width, about 12 μm, there is an off-track margin of about 6 μm or more at one side).

### DISCLOSURE OF THE INVENTION

The present invention intends to overcome the foregoing problems, and an object thereof is to provide a magnetic tape which comprises a non-magnetic support, a primer layer containing non-magnetic powder and formed on a surface of the non-magnetic support, a magnetic layer containing magnetic powder and formed on the upper surface of the primer layer, and a backcoat layer containing non-magnetic powder and formed on the other surface of the non-magnetic support. In this magnetic tape, iron-based magnetic powder comprising needle-like particles is used as the magnetic powder, and the surface smoothness and uniform thickness of the magnetic layer can be ensured, and also, the orientation of the very fine particles of the magnetic powder in the lengthwise direction can be ensured, even if the magnetic layer is formed with a thickness of as thin as 0.09 μm or less. Thus, this magnetic tape is improved in the performance of recording/reproducing signals with short wavelengths. Another object of the present invention is to provide a magnetic tape which hardly causes a decrease in reproducing output due to off-track, even when the recording track width is as narrow as less than 24 μm (particularly 21 μm or less), and when the difference of [(recording track width)−(reproducing track width)] is as small as less than 12 μm. This is accomplished by improving the dimensional stability in the tape widthwise direction against a change in temperature and/or humidity and reducing the amount of the edge weave. A further object of the invention is to provide a magnetic tape cartridge comprising such a magnetic tape.

The present inventors have intensively researched in order to achieve the above objects, and found that, in a magnetic tape which comprises a non-magnetic support, a primer layer containing non-magnetic powder and formed on a surface of the non-magnetic support, a magnetic layer containing magnetic powder and formed on the upper surface of the primer layer, and a backcoat layer containing non-magnetic powder and formed on the other surface of the non-magnetic support, the magnetic layer surely can have a surface smoothness and an uniform thickness and can be improved in the orientation of the magnetic powder in the lengthwise direction, by the following conditions, even when the magnetic layer is formed with a thickness of as thin as 0.09 μm or less. That is, iron-based magnetic powder comprising needle-like particles with an average major axis length of 20 to 60 nm is used as the magnetic powder, and plate-like non-magnetic oxide particles with an average particle size of 10 to 100 nm are contained at least in the primer layer. As a result, this magnetic tape can be improved in the performance of recording/reproducing signals with short wavelengths.

Further, a magnetic tape which shows a small off-track and a lower error rate can be obtained under the following conditions: the thermal expansion coefficient of the tape in the widthwise direction is (0 to 8)×10⁻⁶/° C., and the humidity expansion coefficient of the tape in the widthwise direction is (0 to 10)×10⁻⁶/% RH; and the amount of the edge weave of the tape is 0.8 μm or less.

In the preferred modes, the magnetic tape of the present invention further comprises the following constituents.
(1) The iron-based magnetic powder for use in the magnetic layer comprises needle-like particles with an average major axis length of 20 to 60 nm.
(2) The iron-based magnetic powder comprising needle-like particles for use in the magnetic layer contains 20 to 40 wt. % of cobalt, 10 to 30 wt. % of at least one element selected from rare earth elements, and 3 to 10 wt. % of aluminum, based on the weight of iron.
(3) The squareness ratio (Br/Bs) of the magnetic layer in the lengthwise direction is 0.80 or more.
(4) The plate-like non-magnetic oxide particles for use at least in the primer layer are particles of at least one oxide selected from the group consisting of cerium oxide, zirconium oxide, aluminum oxide, silicon oxide and iron oxide.
(5) At least one of the primer layer and the backcoat layer contains electrically conductive particles with an average particle size of 10 to 100 nm.
(6) Servo signals for controlling the tracking are recorded on the magnetic layer or the backcoat layer.

Further, the magnetic tape cartridge of the present invention comprises one reel of the magnetic tape of the present invention in a box-shaped casing body, and is controlled in tracking by the servo signals recorded on the magnetic tape. The servo signals in this case may be magnetic signals recorded on the magnetic layer or the backcoat layer of the magnetic tape, or optical signals recorded on the backcoat layer. When the servo signals are magnetic signals recorded on the magnetic layer or the backcoat layer, the magnetic signals recorded are preferably reproduced with a reproducing head comprising a magnetoresistance element.

The thermal expansion coefficient of the magnetic tape in the widthwise direction is preferably (−8 to +8)×10⁻⁶/° C. When the coefficient is outside this range, the reproducing heads dislocate from the recording tracks due to the expansion or contraction of the tape due to a change in temperature, so that off-track occurs since the reproducing heads can not read the recorded signals. To surely prevent such off-track, the thermal expansion coefficient of the magnetic tape in the widthwise direction is more preferably (−7 to +7)×10⁻⁶/° C., still more preferably (−5 to +5)×10⁻⁶/° C., most preferably zero.

In one of the preferred modes of the present invention, the humidity expansion coefficient of the magnetic tape in the widthwise direction is (0 to 10)×10⁻⁶/% RH. When the humidity expansion coefficient is outside this range, the reproducing heads dislocate from the recording tracks due to the expansion or contraction of the tape due to a change in humidity, so that off-track occurs since the reproducing heads can not read the recorded signals. To surely prevent such off-track, the humidity expansion coefficient of the magnetic tape in the widthwise direction is more preferably (0 to 8)×10⁻⁶/% RH, still more preferably (0 to 7)×10⁻⁶/% RH, most preferably zero.

According to the present inventors' experiments, there is no instance where the thermal/humidity expansion coefficient of the magnetic tape is negative. However, it is possibly considered that a negative thermal/humidity expansion coefficient may cause off-track. Even when the expansion coefficient is negative, it is needless to say that off-track occurs if the absolute value of the expansion coefficient is outside the above range.

The amount of edge weave is preferably 0.8 μm or less. To more surely prevent off-track, the amount of edge weave is more preferably 0.6 μm or less, still more preferably 0.4 μm or less, most preferably zero. When the amount of edge weave exceeds 0.8 μm, off-track occurs, and the number of errors increases.

As described above, it has been revealed that, when the recording track width is as narrow as 21 μm or less and when the difference of [(recording track width)−(reproducing track width)] is 12 μm or less, not only the absolute value of the edge weave but also the cycle of the edge weave and the tape-running speed are involved in a complicated relationship with the off-track.

Specifically, it is preferable that the following conditions are set for a magnetic tape to be fed at a rate of 4,000 mm/sec. or more:
[α/(Tw−Tr)]≦0.07, and
[α/(Tw−Tr)]×(V/f)≦13.3 [s⁻¹],
wherein the tape-running speed is V[mm/s]; the amount of edge weave having a cycle of f [mm] which is formed on either of the tape edges serving as a reference for the tape running is α[μm]; the recording track width is Tw[μm]; and the reproducing track width is Tr[μm].
In this regard, preferably, the value of [α/(Tw−Tr)]×(V/f) is 8[s⁻¹] or less, more preferably 6[s⁻¹] or less, most preferably zero.

Examples of the plate-like non-magnetic oxide particles contained in the primer layer include the particles of cerium oxide, zirconium oxide, aluminum oxide, silicon oxide and iron oxide. More preferably, such plate-like non-magnetic oxide particles are also contained in the backcoat layer.

These particles in the primer layer improve the surface smoothness of the magnetic layer, the uniformity of the thickness thereof and the orientation of the particles therein. As a result, the dimensional stability of the magnetic tape against a change in temperature and/or humidity is improved. When the thickness of the magnetic layer is so thin as 0.09 μm or less, it is usual that serious influence of the unevenness of the interface between the primer layer and the magnetic layer is given on the surface smoothness and thickness of the magnetic layer. According to the present invention, the plate-like non-magnetic oxide particles in the primer layer added to the layer are superposed on each other in parallel in the course of the steps of coating and drying. Therefore, the interface between the primer layer and the magnetic layer is not uneven, but is formed smooth, which leads to the smooth magnetic layer with an uniform thickness. There is a further problem which arises when the magnetic layer is formed with a thin thickness: the needle-like magnetic particles are not oriented in the lengthwise direction at the interface between the magnetic layer and the primer layer, so that a part of such magnetic particles rise obliquely, penetrating into the primer layer. This phenomenon is too serious to be ignored. However, also in this case, if the plate-like non-magnetic oxide particles are contained in the primer layer, these plate-like particles are arrayed along the interface, with the result that the needle-like magnetic particles do not penetrate into the primer layer so that the orientation of the needle-like magnetic particles is improved. Furthermore, the needle-like magnetic particles are not protruded over the surface of the magnetic layer. Therefore, an increase in error rate due to the abrasion of the magnetic layer after the tape has been fed can be suppressed.

The following is the reason why the dimensional stability of the magnetic tape against a change in temperature and/or humidity is improved. Since the plate-like non-magnetic oxide particles are filled as if superposed on each other in parallel in the primer layer which comprises a matrix composed of a binder and a filler (non-magnetic powder) as mentioned above, the inter action between each of the plate-like non-magnetic oxide particles is enhanced, so that the thermal/humidity expansion coefficients of the layer change from the values of the binder (100 to 300×10⁻⁶/° C. and 30 to 100×10⁻⁶/% RH) close to the values of the filler (<1×10⁻⁶/° C. and <1×10⁻⁶/% RH) Further, since the particles are plate-like shaped, these properties are exhibited two-dimensionally and isotropically, in other words, in not only the lengthwise direction but also the widthwise direction. This is very advantageous and effective to decrease the thermal/humidity expansion coefficients of the magnetic tape in the widthwise direction.

On the other hand, the foregoing effects are low when needle-like, granular or spherical particles are used, and it is necessary to use a large amount of such particles in order to achieve the same level of effect. As a result, the smoothness of the layer is lost.

Further, the plate-like particles in the primer layer and the backcoat layer diminish the variation in thickness, and this is effective to lessen the deformation (stripes and slippage of the edges of the wound tape) of a magnetic sheet from which magnetic tapes with predetermined widths will be slit. As a result, the edge weave of a slit tape with a predetermined width becomes smaller.

In this regard, JP-A-3-237616 discloses that plate-like non-magnetic particles are contained in a primer layer laid between a magnetic layer and a non-magnetic support. This publication describes that the rigidity of the magnetic recording medium is enhanced by containing the particles of ax-iron oxide with an average particle size of 500 nm in the primer layer. However, the invention of this publication is not intended to provide a magnetic tape with a multi-layer structure comprising a very thin magnetic layer, which the present invention is intended to provide. This publication does not refer to plate-like non-magnetic particles with particle sizes of 10 to 100 nm, which had not been known to those skilled in the art, nor discloses the dimensional stability of the tape against changes in temperature and humidity which has been accomplished in the present invention. Further, the effects of improving the surface smoothness and uniform thickness of the magnetic layer and the orientation of the particles in the magnetic layer can not be exhibited in the magnetic layer with a thickness of 2.5 μm or so. Such effects have been firstly exhibited in the magnetic tape of the present invention which comprises a magnetic layer with a thickness of 0.09 μm or less. Furthermore, the plate-like particles with particle sizes of 500 nm disclosed in this publication are not included in the scope of the present invention, i.e., the plate-like non-magnetic oxide particles with an average particle size of 10 to 100 nm specified in the present invention. Therefore, the smoothness of the magnetic layer disclosed in this publication is impaired, and thus, the magnetic tape comprising such a magnetic layer can not obtain excellent performance of recording signals with short wavelengths. JP-A-4-228108, JP-A-8-129724, JP-A-9-198650, JP-A-11-273053 and JP-A-2001-331928 disclose that plate-like non-magnetic particles are contained in the backcoat layers, respectively. However, all the inventions of these publications use plate-like non-magnetic particles with an average particle size exceeding 100 nm. The publication of JP-A-9-198650 describes the use of magnetic magnetite, which is however different from the plate-like non-magnetic oxide particles with an average particle size of 10 to 100 nm as used in the present invention.

The present inventors have firstly discovered that the use of the plate-like non-magnetic particles, with a particle size of 10 to 100 nm, of oxides, preferably at least one oxide selected from the group consisting of cerium oxide, zirconium oxide, aluminum oxide, silicon oxide and iron oxide, in a magnetic tape is effective to decrease the humidity expansion coefficient and the thermal expansion coefficient of the magnetic tape in the widthwise direction. Further, they have firstly succeeded in the synthesis of the oxide particles with such a shape by their own developed techniques.

As will be described in detail later, these oxide particles are prepared as follows: in the first step, an aqueous solution of a salt of a metal which will form these oxide particles is added to an aqueous alkaline solution to obtain a hydroxide or a hydrate, which is then heated at a temperature of 110 to 300° C. in the presence of water to thereby regulate the particles in intended shape and particle size; and in the second step, the particles of the hydroxide or the hydrate are heated in an air. By this method, there can be provided plate-like particles with a particle size of 10 to 100 nm which have high crystallinity and which show an uniform particle distribution, far less sintering and far less agglomeration.

As described above, the step of regulating the shapes and particle sizes of the particles is carried out separately from the step of extracting the intrinsic properties of the materials as much as possible, so that the plate-like particles, with an average particle size of 10 to 100 nm, of cerium oxide, zirconium oxide, aluminum oxide, silicon oxide or iron oxide can be prepared, which is impossible by any of the conventional methods.

Further, plate-like conductive particles of a tin-containing indium oxide, antimony-containing tin oxide or the like can be prepared by a method similar to the method for preparing the above oxide particles. The use of these conductive particles in the primer layer for the magnetic layer or the backcoat layer is effective to not only suppress the thermal and humidity expansion of the magnetic tape in the widthwise direction but also lessen the electrification of the magnetic tape.

### BRIEF DESCRIPTION OF DRAWINGS

FIG. 1 consists of FIGS. 1A to 1C which illustrate examples of the lamination structures of magnetic tapes according to the present invention, in which FIG. 1A is a sectional view of a magnetic tape without an intermediate layer; FIG. 1B is a sectional view of a magnetic tape having an intermediate layer formed on one surface of a non-magnetic support; and FIG. 1C is a sectional view of a magnetic tape having intermediate layers formed on both surfaces of a non-magnetic support.

FIG. 2 is a perspective view of a magnetic tape cartridge according to the present invention, showing a general structure thereof.

FIG. 3 is a sectional view of the magnetic tape cartridge according to the present invention, showing a partly simplified internal structure thereof.

FIG. 4 is a plan view of a part of the magnetic tape, illustrating the edge weave formed on the magnetic tape in an enlarged state.

FIG. 5 schematically illustrates a partly simplified slitting system used for slitting a magnetic sheet in Examples of the present invention.

FIG. 6 is a partial sectional view of a tension cut roller arranged in the slitting system, schematically illustrating a part of the sucking portions.

FIG. 7 is a plan view of a magnetically recording/reproducing apparatus (a tape-driving apparatus) for a magnetic tape cartridge.

FIG. 8 is an enlarged side view of a part of the magnetic tape running along the guide roller arranged in the magnetically recording/reproducing apparatus, viewed from the direction of the allow A on FIG. 7.

FIG. 9 is a diagram of a magnetic tape in which data tracks and servo bands are alternately formed on the magnetically recording surface (the magnetic layer) of the magnetic tape, illustrating an example of the track servo system applied to the magnetic tape.

### BEST MODES FOR CARRYING OUT THE INVENTION

Next, the embodiments of the present invention will be described.

<Magnetic Layer>

The thickness of the magnetic layer is usually 0.09 μm or less, preferably from 0.06 μm or less. When the thickness of the magnetic layer exceeds 0.09 μm, the reproducing output may decrease due to the thickness loss, or the resolution of recorded signals with short wavelengths may lower. When the thickness of the magnetic layer is less than 0.01 μm, it is difficult to form a uniform magnetic layer. Therefore, the thickness of the magnetic layer is generally 0.01 μm or more. The product of the residual magnetic flux density in the lengthwise direction and the thickness of the magnetic layer is preferably from 0.0018 to 0.06 μm, more preferably from 0.0036 to 0.050 μm. When this product is less than 0.0018 μm, the reproducing output by the MR head is insufficient. When this product exceeds 0.06 μm, the reproducing output by the MR head tends to be skewed. The use of a magnetic tape having such a magnetic layer makes it possible to record signals with shorterg wavelengths, increase the reproducing output by the MR head, and decrease the skew in the reproducing output, so that, preferably, the ratio of output to noises can be increased.

The coercive force of the magnetic layer is preferably from 80 to 320 kA/m, more preferably from 100 to 320 kA/m, still more preferably from 120 to 320 kA/m. When the coercive force of the magnetic layer is less than 80 kA/m, the output becomes lower due to demagnetizing field demagnetization, when the recording wavelength is shortened. When the coercive force exceeds 320 kA/m, the recording by the magnetic head becomes difficult.

The center line average surface roughness Ra of the magnetic layer is preferably 6 nm or less, more preferably from 0.5 to 5 nm, still more preferably from 0.7 to 4 nm, far more preferably from 0.7 to 3 nm. If the center line average surface roughness Ra of the magnetic layer is less than 0.5 nm, the feeding of the magnetic tape becomes unstable, while, if it exceeds 5 nm, PW50 (the half width of reproduction output) becomes larger or the output lowers due to a spacing loss, so that the error rate becomes higher.

As the magnetic powder to be added to the magnetic layer, ferromagnetic iron-based metal powder comprising needle-like particles, such as Fe powder and Fe—Co powder are used. The coercive force of the ferromagnetic iron-based metal powder is preferably from 80 to 320 kA/m. The saturation magnetization is preferably from 80 to 200 A·m²/kg (80 to 200 emu/g), more preferably from 100 to 180 A·m²/kg (100 to 180 emu/g) in case of the ferromagnetic iron-based metal powder. Preferably, the ratio of the Co/Fe is 20 to 40 wt. % in order to obtain ferromagnetic iron-based metal powder in the above range.

The magnetic characteristics of the magnetic layer and the ferromagnetic powder are measured with a sample-vibration type fluxmeter under an external magnetic field of 1.273 MA/m (16 kOe).

An average major axis length of the needle-like ferromagnetic iron-based metal particles such as Fe powder and Fe—Co powder to be used in the magnetic recording medium of the present invention is generally from 0.02 to 0.1 μm, preferably from 0.02 to 0.06 μm, more preferably from 0.03 to 0.05 μm. When the average major axis length is less than 0.02 μm, the coercive force of the magnetic powder decreases, or the dispersion of the magnetic powder in the coating composition becomes hard since the agglomeration force of the magnetic powder increases. As a result, an output of signals with shorter wavelengths becomes lower. When the average major axis length exceeds 0.06 μm, the particle noise depending on the particle size becomes larger.

As the average major axis length of the particles becomes shorter, the durability and corrosion resistance of the magnetic layer tend to lower. To minimize the degradation of the durability and corrosion resistance of the magnetic layer, it is preferable to add Al and/or a rare earth element to the ferromagnetic iron-based metal powder. As the rare earth elements, Y, Nd, Sm, Pr and the like are preferred. When Al is contained in the ferromagnetic iron-based metal powder, the amount of Al is adjusted so that the ratio of Al/Fe can be 3 to 10 wt. %. When a rare earth element is contained therein, the amount of the rare earth element is adjusted so that the ratio of the rare earth element/Fe can be 10 to 30 wt. %.

The above average major axis length is determined by actually measuring the particle sizes on a photograph taken with a scanning electron microscope (SEM) and averaging the measured values of 100 particles.

The BET specific surface area of the ferromagnetic iron metal powder is preferably at least 35 m²/g, more preferably at least 40 m²/g, most preferably at least 50 m²/g. The BET specific surface area is generally 100 m²/g or less.

When the average major axis length of the needle-like particles of the ferromagnetic iron-based metal powder becomes shorter, it becomes difficult to give a sufficient moment of orientation to the needle-like magnetic particles, even if the particles are oriented in the lengthwise direction in a magnetic field. For this reason, the squareness ratio (Br/Bm) of the magnetic tape in the lengthwise direction tends to decrease. In the meantime, when the thickness of the magnetic layer becomes thinner, the needle-like magnetic particles penetrating into the primer layer can not be ignored. Thus, the squareness ratio similarly tends to decrease. In the magnetic layer of the present invention which contains needle-like iron-based magnetic particles with an average major axis length of 20 to 60 nm and has a thickness of 0.09 μm or less, it is difficult to sufficiently orient the needle-like magnetic particles in the lengthwise direction. However, the squareness ratio (Br/Bm) is preferably 0.80 or more in order to obtain a large output of recorded signals with shorter wavelengths. As a result of the present inventors' intensive researches, it is found that, by containing plate-like non-magnetic oxide particles with an average particle size of 10 to 100 nm in the primer layer, the tendency of the needle-like magnetic particles' penetrating into the primer layer can be eliminated, so that the magnetic layer with a squareness ratio within the above specified range can be obtained.

As binders to be contained in the primer layer, the magnetic layer and the backcoat layer, the following can be used in combination with a polyurethane resin: that is, at least one resin selected from a vinyl chloride resin, a vinyl chloride-vinyl acetate copolymer, a vinyl chloride-vinyl alcohol copolymer, a vinyl chloride-vinyl acetate-vinyl alcohol copolymer, a vinyl chloride-vinyl acetate-maleic anhydride copolymer, a vinyl chloride-hydroxyl group-containing alkyl acrylate copolymer, nitrocellulose (cellulose resins), and the like. Among them, a combination of a vinyl chloride-hydroxyl group-containing alkyl acrylate copolymer resin and a polyurethane resin is preferably used. Examples of the polyurethane resin include polyesterpolyurethane, polyetherpolyurethane, polyetherpolyesterpolyurethane, polycarbonatepolyurethane, polyestrepolycarbonatepolyurethane, etc.

It is preferable to use a binder such as a urethane resin or the like which is a polymer having a functional group such as —COOH, —SO₃M, —OSO₃M, —P═O(OM)₃, —O—P=O(OM)₂ [wherein M is a hydrogen atom, an alkali metal base or an amine salt], —OH, —NR¹R², —N⁺R³R⁴R⁵ [wherein R¹, R², R³, R⁴ and R⁵ are the same or different, each independently a hydrogen atom or a hydrocarbon group] or an epoxy group. The reason why such a binder is used is that, as mentioned above, the dispersibility of the magnetic powder, etc. is improved. When two or more resins are used in combination, it is preferable that the polarities of the functional groups of the resins are the same. In particular, the combination of resins both having —SO₃M groups is preferable.

The binder is used in an amount of 7 to 50 wt. parts, preferably from 10 to 35 wt. parts, based on 100 wt. parts of the ferromagnetic powder in the magnetic layer, or based on total 100 wt. parts of the carbon black and the non-magnetic powder in the primer layer. In particular, the best combination as the binder for the primer layer and/or the magnetic layer is 5 to 30 wt. parts of a vinyl chloride-based resin and 2 to 20 wt. parts of a polyurethane resin.

It is preferable to use the binder in combination with a thermally curable crosslinking agent which bonds with the functional groups in the binder to crosslink the same. Preferable examples of the crosslinking agent include isocyanates such as tolylene diisocyanate, hexamethylene diisocyanate and isophorone diisocyanate; and polyisocyanates such as reaction products of these isocyanates with compounds each having a plurality of hydroxyl groups such as trimethylolpropane, and condensation products of these isocyanates; and the like. The crosslinking agent is used in an amount of usually 5 to 50 wt. parts, preferably 7 to 35 wt. parts, based on 100 wt. parts of the binder. If the amount of the crosslinking agent contained in the magnetic layer is decreased (to 0 to less than 100%) as compared with the crosslinking agent contained in the primer layer, there is no problem because the crosslinking agent is dispersed and supplied from the primer layer.

The magnetic layer may contain conventional carbon black (CB) to improve the conductivity and the surface lubricity. As this carbon black, acetylene black, furnace black, thermal black, etc. may be used. Carbon black having a particle size of 5 to 100 nm is generally used, and carbon black having a particle size of 10 to 100 nm is preferably used. When the particle size of carbon black is less than 10 nm, the dispersion of the carbon black particles is difficult. When the particle size of carbon black exceeds 100 nm, a large amount of carbon black should be added. In either case, the surface of the magnetic layer becomes rough and thus the output tends to decrease.

The amount of carbon black is preferably from 0.2 to 5 wt. %, more preferably from 0.5 to 4 wt. %, still more preferably from 0.5 to 3.5 wt. %, and far preferably 0.5 to 3 wt. %, based on the weight of the ferromagnetic powder. When the amount of carbon black is less than 0.2 wt. %, the effect of carbon black is insufficient. When the amount of carbon black exceeds 5 wt. %, the surface of the magnetic layer becomes rough.

When plate-like conductive particles are added to the magnetic layer, the amount thereof is preferably 0.5 to 10 wt. %. As such conductive particles, plate-like particles of tin-containing indium oxide or antimony-containing tin oxide, graphite, plate-like carbon particles and plate-like oxide particles coated with carbon layers can be used. The plate-like particles with particle sizes of 10 to 100 nm are particularly preferable because the use thereof is very effective to reduce the electrical resistance.

<Primer Layer>

The thickness of a primer layer is preferably from 0.3 to 1.0 μm, more preferably from 0.3 to 0.8 μm. When the thickness of the primer layer is less than 0.3 μm, the durability of the magnetic recording medium may degrade. When the thickness of the primer layer exceeds 1.0 μm, the effect to improve the durability of the magnetic recording medium is saturated, and the total thickness of the magnetic tape increases, and the length of the tape per one reel decreases, so that the recording capacity decreases.

The primer layer contains plate-like non-magnetic oxide particles with particle sizes of 10 to 100 nm, preferably the plate-like particles of at least one oxide selected from the group consisting of cerium oxide, zirconium oxide, aluminum oxide, silicon oxide and iron oxide. The amount of the oxide particles to be added is preferably 20 to 85 wt. % based on the weight of a whole of the inorganic powder in the primer layer. The addition of such an amount of the oxide particles is effective to control the thermal expansion coefficient and the humidity expansion coefficient of the magnetic tape in the widthwise direction to (0 to 8)×10⁻⁶/° C. and (0 to 10)×10^{-6/}% RH, and simultaneously to reduce the surface roughness of the magnetic layer formed on the primer layer by a wet-on-wet method, to thereby improve the orientation of the needle-like magnetic particles in the magnetic layer.

When conductive particles are added to the primer layer, the amount thereof is preferably 10 to 70 wt. % based on the weight of a whole of the inorganic powder. As the conductive particles, there can be used plate-like particles of tin-containing indium oxide or antimony-containing tin oxide, graphite, plate-like carbon particles and plate-like oxide particles coated with carbon layers. The plate-like particles with particle sizes of 10 to 100 nm are particularly preferable because the use thereof is very effective to reduce the electric resistance. This is because the electric resistance of the plate-like conductive particles is essentially low, and also because the contact resistance becomes smaller since the plate-like particles contact one another at their plane faces.

As such conductive particles, conventional carbon black (CB) can be used other than the plate-like particles of tin-containing indium oxide or antimony-containing tin oxide, graphite, plate-like carbon particles and plate-like oxide particles coated with carbon layers. Examples of carbon black to be added to the primer layer are acetylene black, furnace black, thermal black, etc. Such carbon black usually has a particle size of 5 to 200 nm, preferably 10 to 100 nm. When the particle size of carbon black is 10 nm or less, it is difficult to disperse the carbon black particles in the primer layer since carbon black has a structure. When the particle size of carbon black exceeds 100 nm, the surface smoothness of the primer layer is poor.

The amount of carbon black to be contained in the primer layer may depend on the particle size of carbon black, and it is preferably from 0 to 15 wt. % based on the weight of a whole of the inorganic powder. When the amount of carbon black exceeds 15 wt. %, it becomes difficult to array the plate-like particles in parallel with the coating layer. More preferably, carbon black with a particle size of 15 to 80 nm is used in an amount of 0 to 15 wt. %, and still more preferably, carbon black with a particle size of 20 to 50 nm is used in an amount of 0 to 10 wt. %. When carbon black with the above particle size is used in the above-specified amount, the electrical resistance of the primer layer is decreased and the tape-feeding irregularity is lessened.

Further, non-magnetic oxide particles of non-magnetic iron oxide and alumina may be added to the primer layer in addition to the above plate-like oxide particles, so as to control the viscosity of the coating composition for the primer layer and the rigidity of the magnetic tape. As the non-magnetic iron oxide, preferably used are needle-like non-magnetic iron oxide particles with a major axis length of 50 to 200 nm and a minor axis length (particle size) of 5 to 200 nm, or granular or irregular-shaped iron oxide particles with a particle size of 5 to 200 nm, preferably 5 to 150 nm, more preferably 5 to 100 nm.

The amount of the non-magnetic particles to be added to the primer layer is preferably from 0 to 20 wt. % based on the weight of a whole of the inorganic powder, although this amount depends on the kind of the plate-like oxide particles as the main oxide particles. When the amount of the non-magnetic particles exceeds 20 wt. %, it becomes difficult to array the plate-like particles in parallel with the coating layer.

The main use of the plate-like oxide particles with a particle size of 10 to 100 nm, preferably such plate-like particle of at least one oxide selected from the group consisting of cerium oxide, zirconium oxide, aluminum oxide, silicon oxide and iron oxide, in combination with other shape of oxide particles or oxide particles with other particle size is also possible in order to control the viscosity of the coating composition and the rigidity of the magnetic tape. More preferably, non-magnetic particles surface-treated with Al or Si are used so as to improve the dispersibility.

Otherwise, the primer layer may comprise two layers: the lower primer layer is a known primer layer to which conductivity is imparted, and the upper primer layer is a layer containing the above plate-like non-magnetic oxide particles. This is advantageous because the use of expensive plate-like conductive particles is not necessary, which results in decrease in production cost.

<Lamination Structure of Magnetic Tape, and Coefficients of Thermal Expansion and Humidity Expansion of Constitutive Materials>

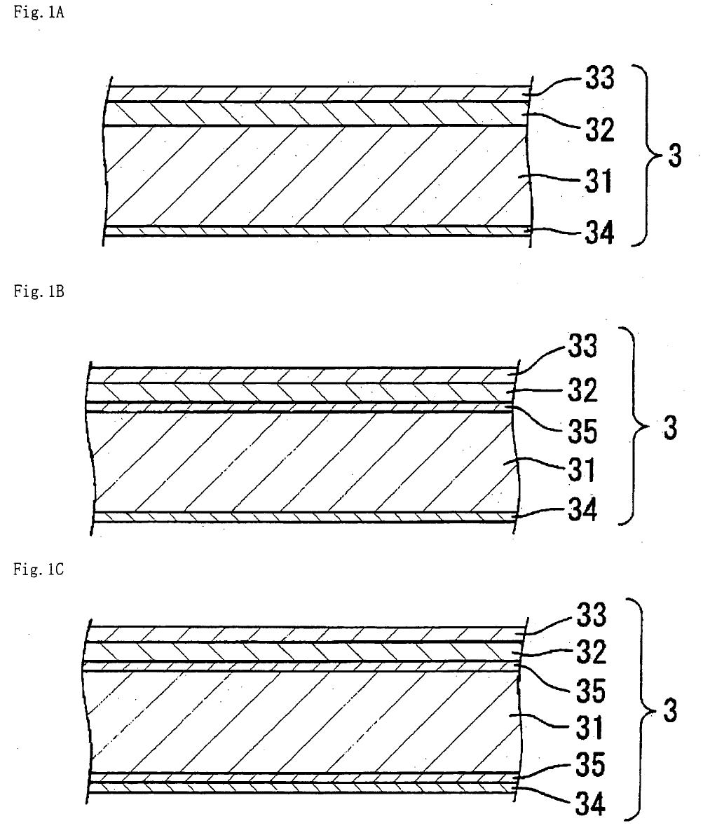

FIGS. 1A, 1B and 1C show examples of the lamination structures of magnetic tapes according to the present invention. In each of FIGS. 1A to 1C, numeral 3 refers to a magnetic tape; 31, to a non-magnetic support; 32, to a primer layer; 33, to a magnetic layer; 34, to a backcoat layer; and 35 to an intermediate layer provided between the non-magnetic support (31) and the primer layer (32).

<Structure of Magnetic Tape Cartridge>

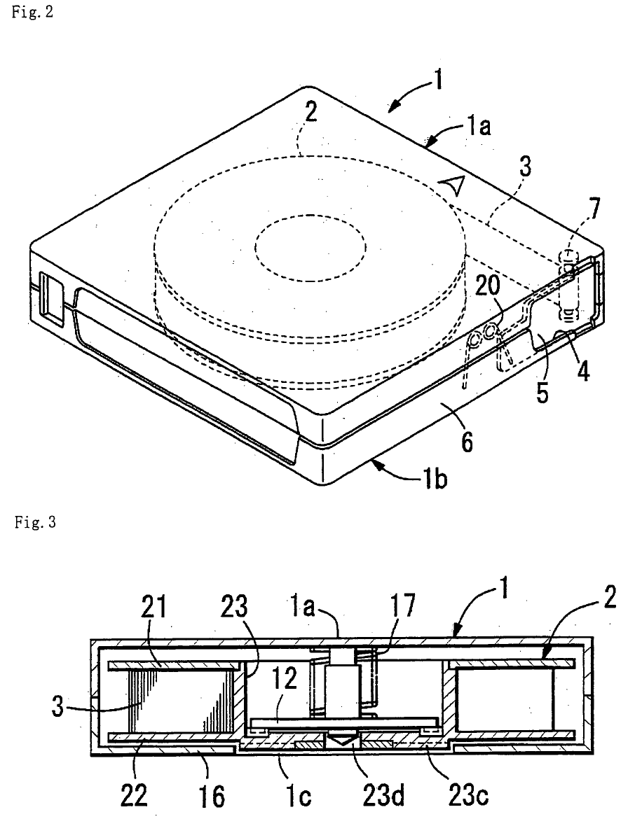

FIG. 2 illustrates a structure of a magnetic tape cartridge according to the present invention, and FIG. 3 shows the internal structure thereof. As seen in FIG. 2, the magnetic tape cartridge comprises a box-shaped casing body (1) obtained by bonding the upper and lower casings (1a and 1b) to each other, one reel (2) arranged inside the casing body (1), and a magnetic tape (3) wound onto the reel (2). A tape-drawing outlet (4) is opened on one side of the front wall (6) of the casing body (1), and the outlet (4) is opened or closed by a slidable door (5). A tape-drawing member (7) is combined to the end portion at which the magnetic tape (3) is drawn out, in order to draw out the magnetic tape (3) wound onto the reel (2) from the casing. Numeral 20 refers to a door spring for urging the door (5) to automatically move to a closing position.

As shown in FIG. 3, the reel (2) comprises an upper flange portion (21), a lower flange portion (22), and a winding shaft (23) which is formed integrally with the lower flange portion (22) and which is formed in the shape of a bottomed cylindrical body opened at the upper portion. The base wall (23c) of the winding shaft (23) is located over the inlet (1c) of the base wall of the casing, through which a driving shaft is inserted into the casing. Gear teeth are formed on the outer periphery of the base wall (23c) of the winding shaft (23), and such gear teeth are to engage with a member of a tape-driving apparatus (a magnetically recording/reproducing apparatus). A hole (23d) is formed at the center of the base wall (23c) of the winding shaft (23), and this hole (23d) is to allow an unlocking pin (not shown) of the tape-driving apparatus to enter the casing. Further, a reel-locking mechanism for preventing unnecessary rotation of the reel (2) is provided in the casing body (1). Numeral 12 refers to a braking button composing this reel-locking mechanism, and numeral 17 refers to a spring for urging the braking button (12) downwardly on the figure.

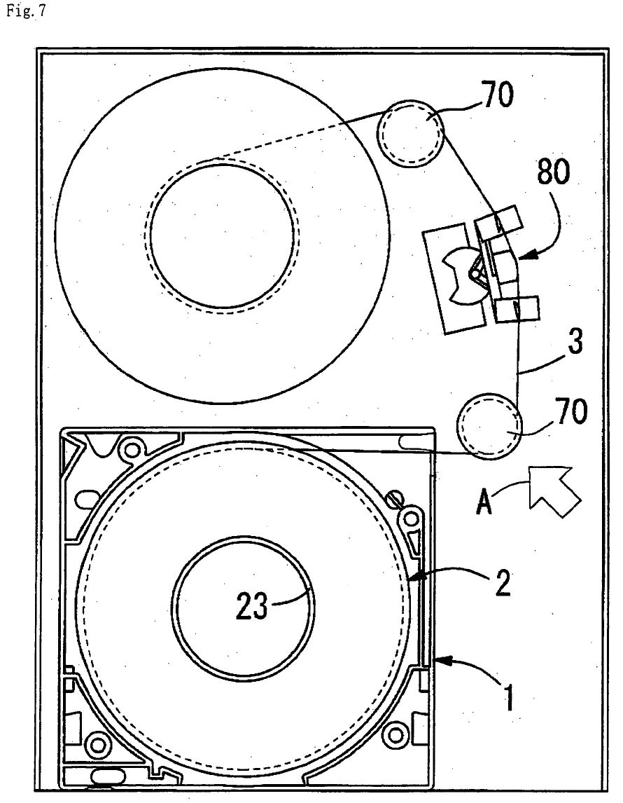

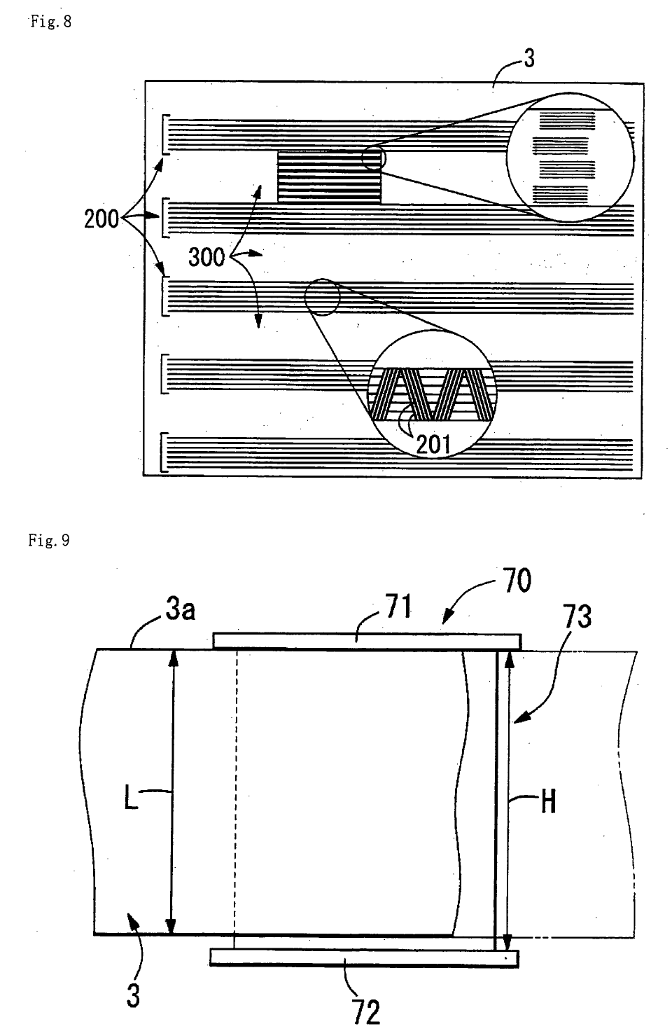

The magnetic tape (3) set in the magnetic tape cartridge is tracked under the control of the servo signals recorded on the magnetic tape (3), while the position of one tape edge (3a), which is on the side of reference for the running of the tape, is regulated toward the outward in the tape widthwise direction. FIG. 9 shows a guide roller (70) which is arranged in the tape-driving apparatus (the magnetic recording/reproducing apparatus) shown in FIG. 7, and which is viewed from the arrow direction A on FIG. 7. Numerals 71 and 72 in FIG. 9 refer to flanges in the guide roller (70); notation H indicates the width of a groove (73) formed between the flanges (71) and (72); and notation L indicates the width of the magnetic tape (3).

In the above case, servo signals may be recorded as magnetic signals on the magnetically recording layer or the backcoat layer of the magnetic tape, or may be pits formed on the backcoat layer of the magnetic tape, or may be formed as optical signals, using a material capable of absorbing light. In other words, the magnetic tape cartridge of the present invention can be applied to both of the magnetic servo system and the optical servo system.

To increase the recording density, preferably, the magnetically recorded signals formed on the magnetic tape in the magnetic tape cartridge of the present invention are reproduced with reproducing heads which comprise magnetoresistance elements (MR heads). Furthermore, in case of the magnetic servo system, it is preferable that the servo signals are also reproduced with the MR heads.

<Structure of Edges of Magnetic tape>

The present invention is intended to provide a magnetic tape which has a larger recording capacity and permits higher access speed and transfer speed, particularly a magnetic tape which has an off-track margin, i.e., [(recording track width)−(reproducing track width)], of as narrow as less than 12 μm, and which can be driven to run at a speed of 4,000 mm/sec. or higher. In such a magnetic tape, the off-track margin is narrower and the tape-running speed is higher than the conventional magnetic tapes. Therefore, even such a slight fluctuation in the tape widthwise direction, which has never caused any disclocation from the tracks in the conventional magnetic tapes, may possibly cause dislocation from the tracks in this magnetic tape. In view of prevention of off-track, it is preferable to lessen the edge weave amount as much as possible. By taking into account the technical difficulties therefor, in other words, the possibility of realization, it is effective to restrict the edge weave amount within a specific range, in connection with the off-track margin, the tape-running speed and the cycle of the edge weave.

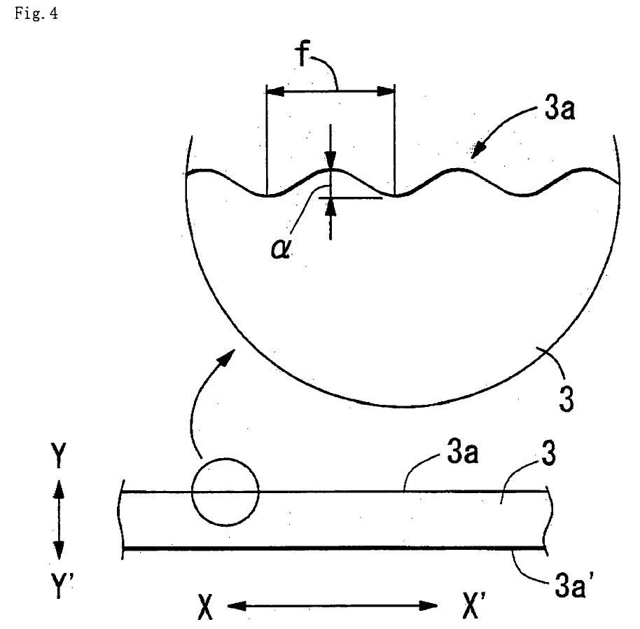

From such a viewpoint, in a magnetic tape (3) for use in a magnetic tape cartridge shown in FIGS. 2 and 3, the fluctuation amount of the tape in the widthwise direction (the direction Y-Y′ on FIG. 4) because of the edge weave having a cycle of f formed on one of the edges (3a, 3a′) of the tape as shown in FIG. 4, namely, the edge weave amount, is determined so as to satisfy the following equation (1) or (2):
[α/(Tw−Tr)]≦0.07 (1)
[α/(Tw−Tr)]×(V/f)≦13.3 [s⁻¹] (2)
wherein
α: the amount of edge weave formed on one edge or the other edge of the tape which serves as the reference side for the running of the tape (the edge weave amount) [unit: μm],
Tw: the width of the recording track [unit: μm],
Tr: the width of the reproducing track [unit: μm],
V: the running speed of the magnetic tape [unit: mm/sec.], and
f: the cycle of the edge weave [unit: mm].

In this regard, the running direction of the magnetic tape (3) is indicated by notations X-X′ on FIG. 4.

When the difference of [(recording track width)−(reproducing track width)] is so small as less than 12 μm, and where the tape-running speed is as fast as 4,000 mm/sec. or higher, off-track tends to occur. This is because, when the above value of [a/(Tw−Tr)] exceeds 0.07 in this case and when dislocation from the tracks is caused by a change in the widthwise dimension of the tape in association with a change in humidity and/or temperature, the dislocation from the tracks due to the edge weave synergistically acts with the above dislocation. This phenomenon can be confirmed by the results of the evaluation of Examples and Comparative Examples which will be described later.

The occurrence of off-track also relates to the ratio of the tape-running speed V to the cycle f of the edge weave (V/f), that is, the frequency of the tape widthwise vibrations which are caused by the edge weave having a cycle of f while the tape is running. Also, the off-track tends to occur when the product of the ratio (V/f) and the value of [α/(Tw−Tr)] exceeds 13.3 [s⁻¹=Hz]. The cycle f [mm] of the edge weave which has an influence on the off-track of the magnetic tape (3) is normally found by the equation: f/V≦0.02 [unit: sec.], in other words, 50≦V/f [s⁻¹=Hz]. Particularly when an edge weave with a cycle of f which satisfies the equation of 200≦V/f [s⁻¹] is present, the off-track amount becomes larger. This is because, since the magnetic head array (80) provided in the tape drive as shown in FIG. 7 has a large mass as a whole, the motion of the magnetic head array (80) cannot follow the tracks on the magnetic tape, even though the cycle of the edge weave of the tape is relatively long, as the running speed V of the tape is more and more increased.

When the above off-track margin (Tw−Tr) is 12 μm or less, and also when the tape running speed is 4,000 mm/sec. or higher (4,000≦V [mm/sec.]), off-track more often occurs, as the difference (Tw−Tr) between the recording track width (Tw) and the reproducing track width (Tr) becomes smaller and smaller, and as the edge weave amount α becomes larger and larger. This is because the smaller difference (Tw−Tr) results in a smaller off-track margin, and because, the larger the edge weave amount, the larger the fluctuation of the magnetic tape in the widthwise direction becomes, while the tape is running. As described above, the cycle f [mm] of the edge weave giving an influence on the off-track is a value which satisfies the relationship of f/V≦0.02 [unit: sec.], namely, 50≦V/f[s⁻¹=Hz], provided that the tape running speed is V [mm/sec.). When the tape-running speed V is, for example, 4,000 mm/sec., the cycle f of the edge weave which has an influence on off-track is 80 mm or less (particularly 20 mm or less). When the amount a of the edge weave having this cycle is set at 0.8 μm or less (preferably 0.6 μm or less), the off-track amount becomes smaller, and thus, excellent servo tracking performance can be achieved.

<Coefficient of Dynamic Friction>

Abnormal tape-running also causes off-track. Abnormal tape-running is caused by the following. (1) Unbalance between a coefficient of dynamic friction of the magnetic layer of a magnetic tape against the slider (material: alumina/titania/carbide (ALTIC)) and a coefficient of dynamic friction of the magnetic layer of the magnetic tape against the guide roller (material: aluminum) (since the coefficient of dynamic friction of the magnetic layer of the magnetic tape against aluminum is equal to the coefficient of dynamic friction of the magnetic layer of the magnetic tape against SUS, the latter coefficient is used instead, because the measurement of the latter coefficient is established.); and (2) the shape of the servo signal-writing head is unsuitable.

Particularly when the coefficient of dynamic friction of the magnetic tape against the slider (ALTIC) is large, the off-track amount increases, because the magnetic tape moves in the widthwise direction while the magnetic head array moves in the widthwise direction of the magnetic tape. Therefore, it is preferable to set the coefficient of dynamic friction of the magnetic layer of the magnetic tape against the slider (ALTIC) at 0.35 or less, preferably within a range of from 0.1 to 0.3, more preferably within a range of 0.1 to 0.25. Generally, the coefficient of dynamic friction of the magnetic layer of the magnetic tape against SUS is from 0.1 to 0.3, and the coefficient of dynamic friction of the backcoat layer of the magnetic tape against SUS is from 0.1 to 0.3. It is difficult to decrease these coefficients of dynamic friction to less than 0.10.

The coefficient of dynamic friction of the magnetic layer against SUS is a value measured as follows: the magnetic tape is hung on a SUS pin (SUS304) which has an outer diameter of 5 mm and a surface roughness of 0.1 s, at an angle of 90 degrees under a load of 0.64 N; and, after a portion of the magnetic tape is slid 10 times on the SUS pin at a feeding speed of 20 mm/sec., the coefficient of dynamic friction is measured. The coefficient of dynamic friction of the magnetic layer against ALTIC is a value measured as follows: the magnetic tape is hung on an ALTIC pin which has an outer diameter of 7 mm and a surface roughness of 0.1 s, at an angle of 90 degrees under a load of 0.64 N; and, after a portion of the magnetic tape is slid 10 times on the ALTIC pin at a feeding speed of 20 mm/sec., the coefficient of dynamic friction is measured.

A position error signal (or PES) due to the abnormal tape-running becomes lower, when the ratio of [(μₘₛ₁)/(μ_{mSUS})] is 0.7 to 1.3, wherein μₘₛ₁ is a coefficient of dynamic friction of the magnetic layer of the magnetic tape against the slider material; and μ_{mSUS} is a coefficient of dynamic friction of the magnetic layer of the magnetic tape against SUS. Furthermore, the off-track due to the abnormal tape-running becomes smaller, when the ratio of [(μₘₛ)/(μ_{bSUS})] is 0.8 to 1.5, wherein μ_{bSUS} is a coefficient of dynamic friction of the backcoat layer of the magnetic tape against SUS.

Hereinafter, the preferred examples of the components of a magnetic tape according to the present invention will be explained in more detail.

<Non-Magnetic Support>

The coefficient of thermal expansion in the widthwise direction of a non-magnetic support is preferably within a range of (−10 to +8)×10⁻⁶/° C., more preferably (−10 to +5)×10⁻⁶/° C. If the coefficient of thermal expansion is outside the above range, off-track occurs, and the error rate increases, because the thermal expansion coefficient of the magnetic tape in the widthwise direction is outside the range of (−8 to +8)×10⁻⁶/° C.

The coefficient of humidity expansion in the widthwise direction of the non-magnetic support is preferably within a range of (0 to 10)×10⁻⁶/% RH, more preferably (0 to 7)×10⁻⁶/% RH. If the coefficient of humidity expansion is outside the above range, off-track occurs, and the error rate increases, because the humidity expansion coefficient of the magnetic tape in the widthwise direction is outside the range of (0 to 10)×10⁻⁶/% RH.

The thickness of the non-magnetic support is preferably 6.0 μm or less, more preferably from 2.0 to 6.0 μm. When the thickness of the non-magnetic support exceeds 6.0 μm, the total thickness of the magnetic tape increases so that the recording capacity per reel decreases. When the thickness of the non-magnetic support is less than 2 μm, it is difficult to form a film, and the strength of the resultant magnetic tape tends to lower.

The total thickness of the magnetic tape including the non-magnetic support is preferably 2.5 to 7.7 μm. This is because the tape strength is weak when the total thickness is less than 2.5 μm, and because the recording capacity per reel becomes smaller when the total thickness exceeds 7.7 μm.

The Young's modulus E of the non-magnetic support in the lengthwise direction depends on the thickness of the non-magnetic support, and it is usually at least 4.9 GPa (500 kg/mm²), preferably at least 5.9 GPa (600 kg/mm²), more preferably at least 6.9 GPa (700 kg/mm²). When the Young's modulus of the support is less than 4.9 GPa (500 kg/mm²), the strength of the magnetic tape tends to decrease or the feeding of the magnetic tape becomes unstable.

The ratio of Young's modulus MD in the lengthwise direction to Young's modulus TD in the widthwise direction (MD/TD) of the non-magnetic support is preferably from 0.1 to 1.8, more preferably from 0.3 to 1.7, still more preferably from 0.5 to 1.6. When this ratio is within the above range, the head touch is improved. As a material for the non-magnetic support, a polyethylene terephthalate film, a polyethylene naphthalate film, an aromatic polyamide film, an aromatic polyimide film or the like is used.

Generally, both the magnetic layer-forming surface and the backcoat layer-forming surface of the non-magnetic support have a center line average surface roughness Ra of 5.0 to 10 nm. In order to decrease the spacing loss by decreasing the center line average surface roughness Ra of the magnetic layer, a non-magnetic support which has a magnetic layer-forming surface having a center line average surface roughness Ra of 1.0 to 5.0 nm (the Ra of the backcoat layer-forming surface is 5.0 to 10 nm) is used. The non-magnetic support of this type is called dual type, which is made by laminating two types of non-magnetic supports.

<Lubricant>

A coating layer comprising a primer layer and a magnetic layer may contain lubricants having different functions. Preferably, the primer layer contains 0.5 to 5.0 wt. % of a higher fatty acid and 0.2 to 3.0 wt. % of a higher fatty acid ester based on the weight of the entire powder components in the magnetic layer and the primer layer, because the coefficient of dynamic friction of the magnetic tape against the heads can be decreased. When the amount of the higher fatty acid is less than 0.5 wt. %, the effect to decrease the coefficient of friction is insufficient. When the amount of the higher fatty acid exceeds 5.0 wt. %, the primer layer may be plasticized and thus the toughness of the primer layer may be lost. When the amount of the higher fatty acid ester is less than 0.2 wt. %, the effect to decrease the coefficient of friction is insufficient. When the amount of the higher fatty acid ester exceeds 3.0 wt. %, the amount of the higher fatty acid ester which migrates to the magnetic layer becomes too large, so that the magnetic tape may stick to the heads.

It is preferable to use a fatty acid having 10 or more carbon atoms. Such a fatty acid may be a linear or branched fatty acid, or an isomer thereof such as a cis form or trans form. Among them, a linear fatty acid is preferable because of its excellent luburicity. Examples of such a fatty acid include lauric acid, myristic acid, stearic acid, palmitic acid, behenic acid, oleic acid, linoleic acid, etc. Among them, myristic acid, stearic acid and palmitic acid are preferable. The amount of the fatty acid to be added to the magnetic layer is not particularly limited, since the fatty acid migrates between the primer layer and the magnetic layer. Thus, the total amount of the fatty acids in the magnetic layer and the primer layer is selected within the above range. When the fatty acid is added to the primer layer, the magnetic layer does not necessarily contain the fatty acid.

The coefficient of friction of the magnetic tape being run can be decreased, when the magnetic layer contains 0.5 to 3.0 wt. % of a fatty acid amide and 0.2 to 3.0 wt. % of a higher fatty acid ester based on the weight of the magnetic powder. When the amount of the fatty acid amide is less than 0.5 wt. %, the heads tend to directly contact the magnetic layer, and thus, the burning-preventive effect is poor. When the amount of the fatty acid amide exceeds 3.0 wt. %, the fatty acid amide may bleed out and causes a defect such as dropout. As the fatty acid amide, fatty acid amides each having at least 10 carbon atoms such as the amides of palmitic acid, stearic acid and the like can be used.

The addition of less than 0.2 wt. % of a higher fatty acid ester is insufficient to decrease the coefficient of friction, while-the addition of 3.0 wt. % or more of a higher fatty acid ester gives an adverse influence such as adhesion of the magnetic tape to the heads. The intermigration of the lubricants of the magnetic layer and the primer layer between both the layers may be allowed.

The coefficient of dynamic friction of the magnetic layer of the magnetic tape against the slider of the MR head is preferably 0.35 or less, more preferably from 0.1 to 0.3, still more preferably from 0.1 to 0.25, in order to lower PES. When this coefficient of dynamic friction exceeds 0.30, the spacing loss tends to arise due to the contamination of the slider. In addition, the off-track amount increases, because the magnetic tape moves in the widthwise direction when the magnetic head array is moved in the widthwise direction of the tape. The coefficient of dynamic friction of less than 0.10 is hardly realized.

The coefficient of dynamic friction of the magnetic layer against SUS is usually from 0.1 to 0.3, preferably from 0.10 to 0.25, more preferably from 0.12 to 0.20. When this coefficient of dynamic friction exceeds 0.25, the guide rollers may be easily contaminated. It is difficult to decrease this coefficient of dynamic friction to less than 0.10.

The ratio of μₘₛ₁ to μ_{mSUS} [(μₘₛ₁)/(μ_{mSUS})] is preferably from 0.7 to 1.3, more preferably from 0.8 to 1.2, wherein μₘₛ₁ is a coefficient of dynamic friction of the magnetic layer against the slider material; and μ_{mSUS} is a coefficient of dynamic friction of the magnetic layer against SUS. In this preferred range, dislocation from the tracks (off-track) due to the abnormal feeding of the magnetic tape becomes smaller.

<Backcoat Layer>

To improve the tape-running performance, a conventional backcoat layer with a thickness of from 0.2 to 0.6 μm may be provided on the other surface of the non-magnetic support. When the thickness of the backcoat layer is less than 0.2 μm, the effect to improve the tape-running performance is insufficient. When the thickness of the backcoat layer exceeds 0.6 μm, the total thickness of the magnetic tape increases, so that the recording capacity per one reel of the tape decreases.

The coefficient of dynamic friction between the backcoat layer and SUS is preferably from 0.10 to 0.30, more preferably from 0.10 to 0.25. When this coefficient of dynamic friction is less than 0.10, the magnetic tape excessively slips on the guide rollers, so that the running of the tape becomes unstable. When this coefficient of dynamic friction exceeds 0.30, the guide rollers are easily contaminated.

The ratio of μₘₛ₁ to μ_{bSUS} [(μₘₛ₁)/(μ_{bSUS})] is preferably from 0.8 to 1.5, more preferably from 0.9 to 1.4. Within this range, dislocation from the tracks (off-track) due to the tape-meandering is lessened.

It is preferable that the backcoat layer contains the above-mentioned plate-like non-magnetic oxide particles with a particle size of 10 to 100 nm,.preferably, particles of at least one oxide selected from the group consisting of cerium oxide, zirconium oxide, aluminum oxide, silicon oxide and iron oxide. The addition amount thereof is preferably 2 to 40 wt. %, more preferably 5 to 30 wt. % based on the weight of a whole of the inorganic powder added to the backcoat layer. As described above, the addition of the plate-like oxide particles makes it easy to array the plane faces of the particles in parallel with the surface of the support due to the mechanical orientation which is done when the backcoat layer is applied. As a result, the backcoat layer shows isotropic properties to the thermal expansion or the humidity expansion of the tape. Further, the particles of the present invention are very fine plate-like particles with a particle size of 10 to 100 nm, and therefore can have a larger surface area than that of granular or spherical particles. Therefore, the addition of a small amount of the plate-like particles can show an excellent preventive effect against the thermal expansion and the humidity expansion of the tape.

When the plate-like non-magnetic oxide particles with an average particle size of 10 to 100 nm are added to the backcoat layer, conductive particles may be used together with the plate-like non-magnetic oxide particles, so as to impart conductivity to the magnetic tape. As the conductive particles, there can be used plate-like particles of tin-containing indium oxide and antimony-containing tin oxide, graphite, plate-like carbon particles, and plate-like oxide particles coated with carbon layers. The addition amount of the conductive particles is preferably 60 to 99 wt. % based on the weight of a whole of the inorganic powder. Plate-like particles with a particle size of 10 to 100 nm are particularly preferable because of their high effect to decrease the electric resistance. These conductive particles essentially have low electric resistance, and also, the use thereof makes it possible to lower the contact resistance since these plate-like particles contact one another at their plane faces.

As described above, the use of the plate-like non-magnetic oxide particles and the plate-like conductive particles in the backcoat layer is preferable, because the thermal and humidity expansion of the magnetic tape can be decreased. Otherwise, the backcoat layer may comprise two layers: one is a layer containing plate-like non-magnetic oxide particles, and the other is a layer containing conventional conductive particles such as carbon black or the like.

It is preferable that the backcoat layer contains carbon black in order to improve the tape running performance. As carbon black to be contained in the backcoat layer, acetylene black, furnace black, thermal black or the like can be used. In general, carbon black with a small particle size and carbon black with a large particle size are used in combination. The particle size of small particle size carbon black is usually from 5 to 100 nm, preferably from 10 to 100 nm. When the particle size of the small particle size carbon black is less than 10 nm, the dispersion thereof is difficult. When the particle size of the small particle size carbon black exceeds 100 nm, a large amount of carbon black is necessary. In either case, the surface of the backcoat layer becomes rough and thus the surface roughness of the backcoat layer may be transferred to the magnetic layer (embossing). When the large particle size black carbon having a particle size of 250 to 400 nm is used in an amount of 5 to 15 wt. % based on the weight of the small particle size carbon black, the surface of the backcoat is not roughened and the effect to improve the tape-running performance is enhanced. The total amount of the small particle size carbon black and the large particle size carbon black is preferably from 60 to 98 wt. %, more preferably from 70 to 95 wt. %, based on the weight of a whole of the inorganic powder.

The center line average surface roughness Ra of the backcoat layer is preferably from 3 to 15 nm, more preferably from 4 to 10 nm.

To increase the strength of the backcoat layer, it is preferable to add iron oxide particles with a particle size of preferably 100 to 600 nm, more preferably 200 to 500 nm, to the backcoat layer. The amount of the iron oxide particles is preferably from 2 to 40 wt. %, more preferably from 5 to 30 wt. %, based on the weight of a whole of the inorganic powder. The strength of the backcoat layer is further improved by adding 0.5 to 5 wt. % of alumina with a particle size of 100 to 600 nm based on the weight of a whole of the inorganic powder.

As a binder to be contained in the backcoat layer, the same resins as those used in the magnetic layer and the primer layer can be used. Above all, the use of a cellulose resin in combination with a polyurethane resin is preferable to decrease the coefficient of friction and to improve the tape-running performance. The amount of the binder in the backcoat layer is usually from 40 to 150 wt. parts, preferably from 50 to 120 wt. parts, more preferably from 60 to 110 wt. parts, still more preferably from 70 to 110 wt. parts, based on total 100 wt. parts of the carbon black and the inorganic non-magnetic powder. When the amount of the binder is less than 50 wt. parts, the strength of the backcoat layer is insufficient. When the amount of the binder exceeds 120 wt. parts, the coefficient of friction increases. Preferably, 30 to 70 wt. parts of a cellulose resin and 20 to 50 wt. parts of a polyurethane resin are used in combination. To cure the binder, a crosslinking agent such as a polyisocyanate compound is preferably used.

The crosslinking agent to be contained in the backcoat layer may be the same ones as those used in the magnetic layer and the primer layer. The amount of the crosslinking agent is usually from 10 to 50 wt. parts, preferably from 10 to 35 wt. parts, more preferably from 10 to 30 wt. parts, based on 100 wt. parts of the binder. When the amount of the crosslinking agent is less than 10 wt. parts, the film strength of the backcoat layer tends to decrease. When the amount of the crosslinking agent exceeds 35 wt. parts, the coefficient of dynamic friction of the backcoat layer against SUS increases.

A special-purpose backcoat layer, on which magnetic servo signals will be recorded, may contain 30 to 60 wt. parts of the same ferromagnetic powder as is used in the magnetic layer, 2 to 15 wt. parts of the foregoing plate-like non-magnetic oxide particles, and 40 to 70 wt. parts of carbon black based on 100 wt. parts of inorganic powder used. As the binder, the same resin as is used in the backcoat layer is used in an amount of usually 40 to 150 wt. parts, preferably 50 to 120 wt. parts, based on total 100 wt. parts of the ferromagnetic powder, the carbon black and the plate-like oxide particles. As the crosslinking agent, the crosslinking agent described above is used usually in an amount of 10 to 50 wt. parts per 100 wt. parts of the binder. For the same reason as described above for the magnetic layer, preferably, the coercive force is from 80 to 320 kA/m, and the product of the residual magnetic flux density Br and the thickness is from 0.018 to 0.06 μm.

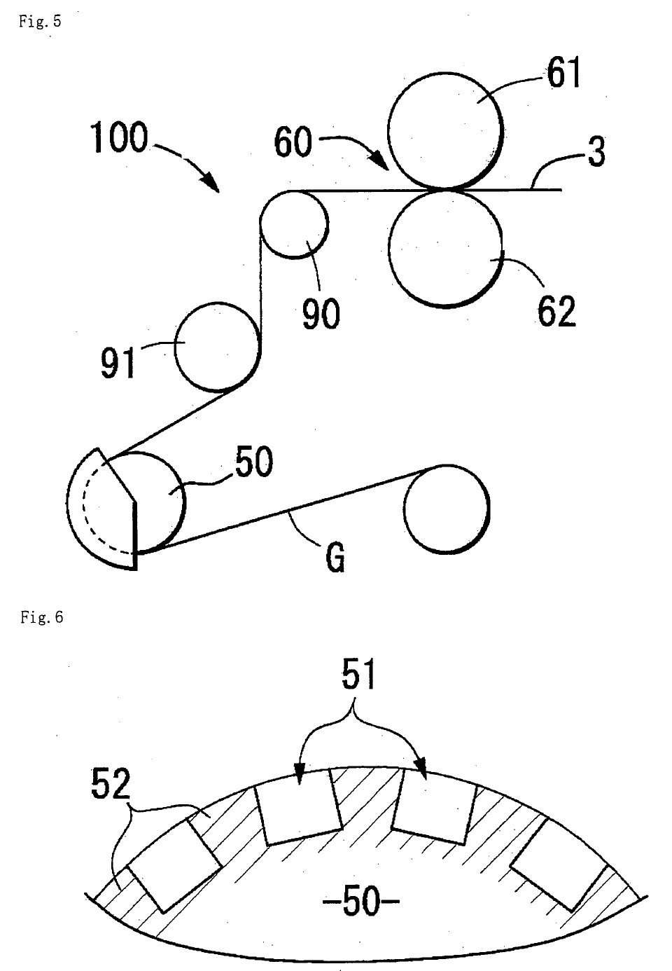

As described above, by adding the plate-like particles with a number-average particle size of 10 to 100 nm to the primer layer, the dimensional stability of the tape against changes in temperature and humidity is improved, and the edge weave of the tape is reduced. The edge weave of the tape can be further reduced by using a partially adapted slitting machine (100) (a machine for slitting a magnetic sheet into magnetic tapes with predetermined widths) as schematically shown in FIG. 5.

The factors which cause, on a tape, an edge weave having a short cycle (for example, 80 mm or less) within such a range that off-track is induced at a tape-feeding speed of 4,000 mm/sec. or so were investigated. As a result, it was found out that the motions of a magnetic sheet G being slit caused a short cyclic fluctuation in the tension of the magnetic sheet, and that this fluctuation caused the edge weave in the tape. Based on this result, the present inventors improved the components of the slitting machine (100): specifically, the tension cut roller (50) disposed in the web route through which the magnetic sheet drawn out reached the group of slitting blades, and the timing belt coupling (not shown) for transmitting power to the blade-driving unit (60) were improved, and the mechanical vibrations of the blade-driving unit (60) were reduced. As a result, the amount of edge weave with a short cycle f (80 nm or less) formed on the edges of a magnetic tape (3) obtained by slitting could be greatly reduced. Above all, the improvement of the tension cut roller (50) for use in controlling the tension of the magnetic sheet G was found to be most effective to suppress the fluctuation of the tape in the widthwise direction due to the short cyclic edge weave: that is, the tension cut roller (50) was adapted into a mesh suction roller having suction holes (51) formed of a porous material, as shown in FIG. 6. In this regard, the suction roller shown in FIG. 6 (or the tension cut roller (50)) comprises suction holes (51) which are communicated with a suction source (not shown) to suck the magnetic sheet, and tape-contacting portions (52) which contact the magnetic sheet at their outer peripheries, wherein these holes and portions are disposed alternately at regular intervals alongside the outer peripheral surface of the suction roller. Numerals 61 and 62 in FIG. 5 are the upper and lower blades which are driven to rotate in the opposite directions to each other; and numerals 90 and 91 are guides disposed along the feeding route for the magnetic sheet G.

Further investigation was made on the factors for causing an edge weave with a cycle of, for example, 60 to 70 mm which easily induces off-track at a tape-feeding speed of about 6 m/sec. As a result, it was found that the timing belt and the coupling for transmitting power to the blade-driving unit had some problems. Thus, a flat belt was used for the timing belt, and a rubber coupling was used instead of the metallic coupling, so that edge weaves with medium cycles could be largely reduced.

Still further investigation was made on a method for reducing the amount of edge weave with a relatively long cycle. As a result, it was found that the amount of edge weave was extremely reduced by directly driving the blade-driving unit with a motor, without any power-transmitting unit.

Still further investigation was made on a method for prolonging the cycle of edge weave of a magnetic tape to, for example, 160 mm or more, at which cycle off-track is not induced even at a tape-feeding speed of 8 m/sec. or higher. As a result, it was found that, by increasing the slitting speed, the cycle f becomes longer according to the rate of increasing the slitting speed and thus that the influence of the cycle f on off-track could be lessened, although the amount of edge weave was hardly changed.

<LRT (Lapping/Rotary/Tissue) Treatment>

Before finishing the magnetic tape, the magnetic layer is subjected to a LRT treatment comprising the steps of lapping, rotary and tissue treatments, so as to optimize the surface smoothness, the coefficients of dynamic friction against the slider of the MR head and the cylinder material, the surface roughness and the shape of the surface. Thereby, the running performance of the magnetic tape is improved, and the spacing loss is reduced, so as to improve the reproducing output by the MR head.

(1) Lapping:

An abrasive tape (lapping tape) is moved by the rotary roll at a constant rate (standard: 14.4 cm/min.) in a direction opposite to the tape-feeding direction (standard: 400 m/min.), and is brought into contact with the surface of the magnetic layer of the magnetic tape while being pressed down by the guide block. In this step, the magnetic tape is polished while the unwinding tension of the magnetic tape and the tension of the lapping tape being maintained constant (standard: 100 g and 250 g, respectively).

The abrasive tape (lapping tape) used in this step may be an abrasive tape (lapping tape) with fine abrasive particles such as M20000, WA10000 or K10000. It is possible to use an abrasive wheel (lapping wheel) in place of or in combination with the abrasive tape (lapping tape). When frequent replacement is necessary, the abrasive tape (lapping tape) alone is used.

(2) Rotary Treatment

A rotary wheel having an air-bleeding groove (standard: width of 1 inch (25.4 mm); diameter of 60 mm; air-bleeding groove width of 2 mm; and groove angle of 45 degrees, manufactured by KYOWA SEIKO Co., Ltd.) is rotated at a constant revolution rate (usually 200 to 3,000 rpm; standard: 1,100 rpm) in a direction opposite to the feeding direction of the magnetic tape, and is brought into contact with the magnetic layer of the magnetic tape at a constant contact angle (standard: 90 degrees).

(3) Tissue Treatment

Tissues (woven fabrics, for example, Traysee manufactured by Toray) are brought into contact with the surface of the backcoat layer and the surface of the magnetic layer of the magnetic tape by rotary bars, respectively, while being fed at a constant rate (standard: 14.0 mm/min.) in a direction opposite to the feeding direction of the magnetic tape. Thus, the magnetic tape is cleaned.

### EXAMPLES

The present invention will be explained in detail by the following Examples, which do not limit the scope of the invention in any way. In Examples and Comparative Examples, “parts” are “wt. parts”, unless otherwise specified.

### Example 1

Firstly, the synthesis of plate-like particles of oxides used in Examples are described.

<Preparation of Alumina Particles>

Sodium hydroxide (375 moles) and 2-aminoethanol (50 L) were dissolved in water (400 L) to form an aqueous alkaline solution. Separately from this aqueous alkaline solution, aluminum chloride (III) heptahydrate (37 moles) was dissolved in water (200 L) to form an aqueous aluminum chloride solution. The resultant aqueous aluminum chloride solution was dropwise added to the aqueous alkaline solution to form a precipitate containing aluminum hydroxide. Then, hydrochloric acid was dropwise added to the precipitate to adjust the pH at 10.2. The precipitate in the form of a suspension was aged for 20 hours, and then was washed with water (in an amount about 1,000 times larger than the volume of the precipitate). The supernatant was removed, and the pH of the precipitate in the form of a suspension was again adjusted at 10.0, using an aqueous sodium hydroxide solution. The suspension of the precipitate was charged in an autoclave and subjected to a hydrothermal treatment at 200° C. for 2 hours.

The resultant product was filtered and dried at 90° C. in an air. The dried product was slightly crushed in a mortar, and treated by heating at 600° C. in an air for one hour to obtain aluminum oxide particles. The resultant particles were treated by heating and washed with water, using an ultrasonic dispersing machine so as to remove the unreacted matters and the residues therefrom. The particles were then filtered and dried.

The X-ray diffraction spectra of the resultant aluminum oxide particles were measured. As a result, the spectrum corresponding to γ-alumina was observed. The shapes of the particles were observed with a transmission electron microscope. As a result, it was found that they are square plate-like particles having a particle size distribution of 30 to 50 nm. The resultant aluminum oxide particles were further treated by heating at 1,250° C. in an air for one hour. The X-ray diffraction spectra of the resultant particles were measured. As a result, the spectrum corresponding to α-alumina was observed. The shapes of the particles were further observed with a transmission electron microscope: the particle sizes (the maximum diameters) of 100 particles were measured, and it was found that they were square plate-like particles having an average particle size of 50 nm.

<Preparation of Iron Oxide Particles>

Sodium hydroxide (375 moles) and 2-aminoethanol (50 L) were dissolved in water (400 L) to form an aqueous alkaline solution. Separately from this aqueous alkaline solution, ferric chloride (III) heptahydrate (37 moles) was dissolved in water (200 L). While the resultant aqueous ferric chloride solution and the aqueous alkaline solution were maintained at 12° C., the aqueous ferric chloride solution was dropwise added to the aqueous alkaline solution to form a precipitate containing iron hydroxide. The pH of the precipitate was 11.3. The precipitate was kept standing at a room temperature for about 20 hours, and then was washed with water (in an amount 1,000 times larger than the precipitate). The resulting supernatant was removed, and an aqueous sodium hydroxide solution was added to adjust the pH of the precipitate at 11.3. Then, it was charged in an autoclave and then subjected to a hydrothermal treatment at 150° C. for 2 hours.

By the hydrothermal treatment, plate goethite (α-FeOOH) was obtained. Further, an aqueous sodium silicate solution was added, in an amount of 1 wt. % in terms of SiO₂, to this goethite under stirring, and hydrochloric acid was added to adjust the pH of the mixture at 7.3. Thus, the SiO₂ coating treatment was done. The resultant plate particles were filtered, dried, and treated by heating in air at 600° C. for one hour, to obtain α-iron oxide particles. The α-iron oxide particles were treated by heating, and washed with water using an ultrasonic dispersing machine so as to remove the unreacted material and residues. Then, the α-iron oxide particles were filtered and dried.

The X-ray diffraction spectra of the resultant α-iron oxide particles were measured. As a result, the spectrum corresponding to α-hematite was observed. The shapes of the particles were observed with a transmission electron microscope: the particle sizes (the maximum diameters of the respective particles) of 100 particles were measured, and it was found that they were hexagonal plate particles with an average particle size of 50 nm.

<Preparation of Tin-Containing Indium Oxide (ITO) Particles>

Sodium hydroxide (375 moles) and 2-aminoethanol (50 L) were dissolved in water (400 L) to form an aqueous alkaline solution. Separately from this aqueous alkaline solution, indium chloride (III) tetrahydrate (33.5 moles) and tin chloride (IV) pentahydrate (3.5 moles) were dissolved in water (200 L) to form an aqueous solution of tin chloride and indium chloride. The resultant aqueous solution of tin chloride and indium chloride was added dropwise to the aqueous alkaline solution to form a precipitate containing a hydroxide or a hydrate of tin and indium. The pH of the precipitate was 10.2. The precipitate in the form of a suspension was aged for 20 hours, and then was washed with water to adjust the pH of the precipitate at 7.6.

Next, an aqueous solution of sodium hydroxide was added to the precipitate in the form of the suspension to adjust the pH thereof at 10.8, and then, it was charged in an autoclave and then subjected to a hydrothermal treatment at 200° C. for 2 hours.

The resultant product was washed with water to adjust the pH at 7.8, and filtered and dried at 90° C. in an air. Then, it was slightly crushed in a mortar and treated by heating at 800° C. in an air for one hour to obtain tin-containing indium oxide particles. The resultant particles were treated by heating and further washed with water using an ultrasonic dispersing machine so as to remove the unreacted material and the residues. An aqueous sodium silicate solution was added, in an amount of 1 wt. % in terms of SiO₂, to the tin-containing indium oxide particles under stirring, and hydrochloric acid was added to adjust the pH of the mixture at 7.3. Thus, the SiO₂ coating treatment was done. The resultant particles were filtered, dried, and treated by heating in air at 600° C. for one hour.

The shapes of the resultant particles were observedd with a transmission electron microscope, and the particle sizes (the maximum diameters of the particles) of 100 particles were measured. As a result, it was found that they were hexagonal plate particles having a particle size distribution of 30 to 50 nm (an average particle size of 40 nm). From the X-ray diffraction spectra, it was known that the particles were formed from a material having the same structure, i.e., tin-containing indium oxide in which the indium was substituted by tin. The average particle size determined using the transmission electron microscope is shown in Table 1.

Next, the components of coating compositions for a primer layer, a magnetic layer and a backcoat layer are described.

<Components of Coating Composition for Primer Layer>

| | | |
|---|---|---|
| (1) | | |
| Plate-like alumina particles | 40 | parts |
| (average particle size: 50 nm) | | |
| Plate-like ITO particles | 60 | parts |
| (average particle size: 40 nm) | | |
| Stearic acid (lubricant) | 2 | parts |
| Vinyl chloride-hydroxypropyl acrylate copolymer | 8.8 | parts |
| (−SO₃Na group content: 0.7 × 10⁻⁴ eq./g) | | |
| Polyester-polyurethane resin | 4.4 | parts |
| (−SO₃Na group content: 1.0 × 10⁻⁴ eq./g) | | |
| Cyclohexanone | 25 | parts |
| Methyl ethyl ketone | 40 | parts |
| Toluene | 10 | parts |
| (2) | | |
| Butyl stearate (lubricant) | 1 | part |
| Cyclohexanone | 70 | parts |
| Methyl ethyl ketone | 50 | parts |
| Toluene | 20 | parts |
| (3) | | |
| Polyisocyanate (crosslinking agent) | 2.0 | parts |
| Cyclohexanone | 10 | parts |
| Methyl ethyl ketone | 15 | parts |
| Toluene | 10 | parts |

<Components of Coating Composition for Magnetic Layer>

| (1) Kneading step | | |
|---|---|---|
| Ferromagnetic iron-based metal powder | 100 | parts |
| [Co/Fe: 25 wt. %, Y/Fe: 25 wt. %, | | |
| Al/Fe: 6 wt. %, σs: 99 A · m²/kg, | | |
| Hc: 215 kA/m, and | | |
| average major axis length: 45 nm] | | |
| Vinyl chloride-hydroxypropyl acrylate copolymer | 12.3 | parts |
| (−SO₃Na group content: 0.7 × 10⁻⁴ eq./g) | | |
| Polyester-polyurethane resin | 5.5 | parts |
| (−SO₃Na group content: 1.0 × 10⁻⁴ eq./g) | | |
| Plate-like alumina particles | 10 | parts |
| (average particle size: 50 nm) | | |
| Plate-like ITO particles | 5 | parts |
| (average particle size: 40 nm) | | |
| Methyl acid phosphate | 2 | parts |
| Tetrahydrofuran (THF) | 9 | parts |
| Methyl ethyl ketone/cyclohexanone (KEK/A) | 20 | parts |
| (2) Diluting step | | |
| Amide palmitate | 1.5 | parts |
| n-Butyl stearate | 1.0 | part |
| Tetrahydrofuran | 65 | parts |
| Methyl ethyl ketone | 245 | parts |
| Toluene | 85 | parts |
| (3) Blending step | | |
| Polyisocyanate (crosslinking agent) | 2.0 | parts |
| Cyclohexanone | 30 | parts |

A coating composition for primer layer was prepared by kneading the components of Group (1) with a kneader, adding the components of Group (2) to the mixture and stirring them, dispersing the mixed components with a sand mill for residence time of 60 minutes, and adding the components of Group (3), followed by stirring and filtering the mixture.

Separately, a magnetic coating composition was prepared by previously mixing the components of Group (1) for the kneading step at a high velocity, kneading the mixed powder with a continuous two-screw kneader; adding the components of Group (2) for the diluting step and diluting the mixture at least in two stages with the continuous two-screw kneader, dispersing the mixture with a sand mill for residence time of 45 minutes; and adding the components of Group (3) for the blending step, followed by stirring and filtering the dispersion.

The coating composition for primer layer was applied on a non-magnetic support made of a polyethylene naphthalate film (PEN manufactured by TEIJIN, with a thickness of 5.2 μm, a coefficient of humidity expansion (tape widthwise direction (TD))=9.0×10⁻⁶/% RH, a coefficient of thermal expansion (TD)=3.0×10⁻⁶/° C., MD=8.8 GPa, and Young's modulus in the lengthwise direction MD/Young'a modulus in the widthwise direction TD=1.2) so that the primer layer could have a thickness of 0.6 μm after dried and calendered. Then, the coating composition for magnetic layer was applied on the primer layer by a wet-on-wet method so that the magnetic layer could have a thickness of 0.06 μm after oriented in a magnetic field, dried and calendered. After the orientation in the magnetic field, the magnetic layer was dried with a drier to obtain a magnetic sheet. The orientation in the magnetic field was carried out by arranging N-N opposed magnets (5 kG) in front of the drier, and arranging, in the drier, two pairs of N-N opposed magnets (5 kG) at an interval of 50 cm and at a position 75 cm before a position where the dryness of the layer was felt by one's fingers. The coating rate was 100 m/min.

<Components of Coating Composition for Backcoat Layer>

| | | |
|---|---|---|
| Carbon black (average particle size: 25 nm) | 9 | parts |
| Carbon black (average particle size: 0.35 μm) | 1 | parts |
| Plate-like iron oxide particles | 10 | parts |
| (average particle size: 50 nm) | | |
| Plate-like ITO particles | 80 | parts |
| (average particle size: 40 nm) | | |
| Nitrocellulose (H1) | 44 | parts |
| Polyester-polyurethane resin | 30 | parts |
| (−SO₃Na group content: 1.0 × 10⁻⁴ eq./g) | | |
| Cyclohexanone | 260 | parts |
| Toluene | 260 | parts |
| Methyl ethyl ketone | 525 | parts |

The components of a coating composition for backcoat layer were dispersed with a sand mill for residence time of 45 minutes and a polyisocyanate as a crosslinking agent (13 parts) was added to the mixture to obtain a coating composition for backcoat layer. After filtration, the coating composition was directly applied to a base film, or applied to the other surface of the magnetic sheet having the magnetic layer formed on its one surface, so that the resultant backcoat layer could have a thickness of 0.5 μm after dried and calendered, and then, the backcoat layer was dried to obtain the magnetic sheet coated with the backcoat layer.

The magnetic sheet, thus obtained, was planished with a seven-stage calender comprising metal rolls, at a temperature of 100° C. under a linear pressure of 150 kg/cm, and wound onto a core and aged at 70° C. for 72 hours. After that, the magnetic sheet was slit into strips with a width of ½ inch.

The components of a slitting machine (a machine for slitting the magnetic sheet into magnetic tapes with predetermined widths) were adapted as follows. The tension cut roller was adapted into a tension cut roller of mesh suction type in which a porous metal was embedded in the sucking portions. The tension cut roller thus adapted was disposed in the web route through which the unwound magnetic sheet reached a group of blades. The blade-driving unit was directly connected to a motor without any power-transmitting mechanism, so that the unit could be directly driven.

A tape obtained by slitting the magnetic sheet was fed at a rate of 200 m/min. while the surface of the magnetic layer thereof was being polished with a lapping tape and a blade, and wiped to finish a magnetic tape. In this regard, K10000 was used as the lapping tape; a carbide blade was used as the blade; and Toraysee (trade name) manufactured by Toray was used to wipe the surface of the magnetic layer. The above treatment was carried out under a feeding tension of 0.294 N. This magnetic tape was set in a cartridge to provide a magnetic tape cartridge (hereinafter referred to as a computer tape).

The resultant computer tape is shown in FIG. 2. As shown in FIG. 2, the computer tape comprises a box-shaped casing body (1) made by bonding upper and lower casings (1a and 1b) to each other, and a magnetic tape (3) wound onto one reel (2) disposed within the casing body (1). A tape-drawing outlet (4) is opened at one end of the front wall (6) of the casing body (1), and the outlet (4) is opened or closed by a slidable door (5). A tape-drawing member (7) is connected to one end of the magnetic tape (3) so as to unwind the magnetic tape (3) wound onto the reel (2) and draw the same from the casing to outside. Numeral 20 in FIG. 2 refers to a door spring for urging the door (5) to a closing position.

### Example 2

A computer tape of Example 2 was made in the same manner as in Example 1, except that granular alumina particles (average particle size of 80 nm) (10 parts) and carbon black (average particle size of 75 nm) (2 parts) were used instead of the plate-like alumina particles (average particle size of 50 nm) (10 parts) and the plate-like ITO particles (average particle size of 40 nm) (5 parts) in the coating composition for magnetic layer.

### Example 3

A computer tape of Example 3 was made in the same manner as in Example 2, except that carbon black (average particle size of 25 nm) (80 parts), carbon black (average particle size of 0.35 μm) (10 parts) and granular iron oxide particles (average particle size of 0.4 μm) (10 parts) were used instead of the carbon black (average particle size of 25 nm) (9 parts), the carbon black (average particle size of 0.35 μm) (1 part), the plate-like iron oxide particles (average particle size of 50 nm) (10 parts) and the plate-like ITO particles (average particle size of 40 nm) (80 parts) in the coating composition for backcoat layer.

### Example 4

A computer tape of Example 4 was made in the same manner as in Example 3, except that plate-like alumina particles (average particle size of 50 nm) (70 parts) and carbon black (average particle size of 25 nm) (30 parts) were used instead of the plate-like alumina particles (average particle size of 50 nm) (40 parts) and the plate-like ITO particles (average particle size of 40 nm) (60 parts) in the coating composition for primer layer.

### Example 5

A computer tape of Example 5 was made in the same manner as in Example 1, except that a conventional suction type tension cut roller was used instead of the mesh suction type tension cut roller in which the porous metal was embedded in the sucking portions, and that a blade-driving unit with a mechanism which comprised a rubber belt and a rubber coupling to transmit power to the blade-driving unit was used instead of the direct drive type blade-driving unit which was directly connected to the motor without any power-transmitting mechanism.

### Example 6

A computer tape of Example 6 was made in the same manner as in Example 2, except that the ferromagnetic iron-based metal powder [Co/Fe: 25 wt. %, Y/Fe: 25 wt. %, Al/Fe: 6 wt. %, σs: 99 A.m²/kg, Hc: 215 kA/m, and average major axis length: 45 nm] was changed to ferromagnetic iron-based metal powder [Co/Fe: 21 wt. %, Y/Fe: 8 wt. %, Al/Fe: 6 wt. %, σs: 155 A.m²/kg, Hc: 188.2 kA/m, and average major axis length: 45 nm].

### Example 7

A computer tape of Example 7 was made in the same manner as in Example 3, except that the ferromagnetic iron-based metal powder [Co/Fe: 25 wt. %, Y/Fe: 25 wt. %, Al/Fe: 6 wt. %, σs: 99 A.m²/kg, Hc: 215 kA/m, and average major axis length: 45 nm] was changed to ferromagnetic iron-based metal powder [Co/Fe: 25 wt. %, Y/Fe: 9.3 wt. %, Al/Fe: 3.5 wt. %, σs: 155 A.m²/kg, Hc: 188.2 kA/m, and average major axis length: 100 nm].

### Comparative Example 1

A computer tape of Comparative Example 1 was made in the same manner as in Example 7, except that needle-like iron oxide particles (average particle size of 100 nm) (60 parts), granular alumina particles (average particle size of 80 nm) (10 parts) and carbon black (average particle size of 25 nm) (30 parts) were used instead of the plate-like alumina particles (average particle size of 50 nm) (40 parts) and the plate-like ITO particles (average particle size of 40 nm) (60 parts) in the coating composition for primer layer; that a conventional suction type tension cut roller was used instead of the mesh suction type tension cut roller in which the porous metal was embedded in the sucking portions; and that a blade-driving unit with a mechanism which comprised a rubber belt and a rubber coupling to transmit power to the blade-driving unit was used instead of the direct drive type blade-driving unit which was directly connected to the motor without any power-transmitting mechanism.

### Comparative Example 2

A computer tape of Comparative Example 2 was made in the same manner as in Example 4, except that plate-like alumina particles (average particle size of 150 nm) were used instead of the plate-like alumina particles (average particle size of 50 nm) in the coating composition for primer layer; that a conventional suction type tension cut roller was used instead of the mesh suction type tension cut roller in which the porous metal was embedded in the sucking portions; and that a blade-driving unit with a mechanism which comprised a rubber belt and a rubber coupling to transmit power to the blade-driving unit was used instead of the direct drive type blade-driving unit which was directly connected to the motor without any power-transmitting mechanism.

### Comparative Example 3

A computer tape of Comparative Example 3 was made in the same manner as in Example 3, except that needle-like iron oxide particles (average particle size of 100 nm) (60 parts), granular alumina particles (average particle size of 80 nm) (10 parts) and carbon black (average particle size of 25 nm) (30 parts) were used instead of the plate-like alumina particles (average particle size of 50 nm) (40 parts) and the plate-like ITO particles (average particle size of 40 nm) (60 parts) in the coating composition for primer layer.

The properties of the above computer tapes were evaluated by measuring the following.

<Output, and Output to Noises>

A drum tester was used to measure the electromagnetic conversion characteristics of the computer tapes. The drum tester was equipped with an electromagnetic induction type head (track width: 25 μm, and gap: 0.1 μm) for use in recoding and a MR head (track width: 8 μm) for use in reproducing. Both the heads were disposed at different positions relative to a rotary drum, and were vertically operated to hold pace with each other in tracking. A proper length of the magnetic tape was unwound from the wound magnetic tape in the cartridge and scrapped, and a further 60 cm of the magnetic was unwound and shaped into a strip with a width of 4 mm, which was then wound around the rotary drum.

Outputs and noises were determined as follows. A rectangular wave with a wavelength of 0.2 μm was written on the tape with a function generator, and an output from the MR head was read onto a spectrum analyzer. A value of a carrier wave with a wavelength of 0.2 μm was defined as an output C from the medium. On the other hand, a noise value N was determined as follows. When the rectangular wave with a wavelength of 0.2 μm was written on the tape, a difference obtained by subtracting an output and a system noise was integrated, and the resultant integration value was used as the noise value N. The ratio of an output from the medium to a noise, C/N, was determined. The values of C and C/N were determined as relative values based on the values obtained from the tape of Comparative Example 1 used as a reference.

<Error Rate>

A LTO drive so adapted as to measure even a thin tape was used to record a signal with a wavelength of 0.55 μm and reproduce the recorded signal. An error rate was determined by the following equation, based on error data (the number of error bits) outputted from the drive.
An error rate=(the number of error bits/the number of written bits)
<Thermal Expansion Coefficient and Humidity Expansion Coefficient of Tape>

A sample with a width of 12.65 mm and a length of 150 mm was prepared by cutting the magnetic sheet along the widthwise direction. The thermal expansion coefficient was determined from a difference between the length of the sample under an atmosphere of 20° C. and 60% RH and the length of the sample under an atmosphere of 40° C. and 60% RH. The humidity expansion coefficient was determined from a difference between the length of the sample under an atmosphere of 20° C. and 30% RH and the length of the sample under an atmosphere of 20° C. and 70% RH. The thermal expansion coefficient and the humidity expansion coefficient herein determined were relative to the tape widthwise direction.

<Measurement of Edge Weave Amount>

The amount of edge weave formed on an edge of the tape, used as the side of reference for tape-running, was continuously measured on the tape with a length of 50 m with an edge weave amount-measuring apparatus (KEYENCE) mounted on the servo writer. Fourier analysis was made on the resultant amount of edge weave, and the amount of edge weave with a cycle f (mm) was determined. It was found that the components with frequencies V/f (1/sec.) which were 50 (1/sec.) or more at a tape-feeding speed of V (mm/sec.) caused off-track. Therefore, the amount of edge weave referred to in the present invention are defined as the components with frequencies V/f (1/sec.) which are 50 (1/sec.) or more. In Examples and Comparative Examples, the amounts of edge weave corresponding to frequencies V/f (V=4,000 mm/sec., and f=65 mm) which equaled 61.5 (1/sec.) were found. The off-track amount due to the edge weave was determined by feeding the tape with a LTO drive unit.

<Amount of Off-Track Due to Changes in Temperature and Humidity>

The maximum dislocation from the position of a track (dislocation from a position 1,400 μm away from a servo track), which was observed when the temperature and the humidity of the ambient atmosphere were changed from 10° C. and 10% RH to 29° C. and 80% RH, respectively, was determined from the coefficient of thermal expansion and the coefficient of humidity expansion of the magnetic tape.

<Decrease in Output>

From the sum of the amount of off-track due to the edge weave and the amount of off-track due to changes in temperature and humidity, a decrease in output was calculated when recording/reproducing were carried out on the tape with the same apparatus having a recording head track width of 12 μm and a reproducing head track width of 10 μm; and a decrease in output was calculated when recording/reproducing were carried out on the tape with an apparatus which comprised heads dislocated 1.5 μm from the positions of the tracks of the tape.

The results and the conditions employed in Examples and Comparative Examples are summarized in Tables 1 and 2. In this regard, “S+G” seen in the row of the item “Slitting machine” in each of Tables 1 and 2 means that a conventional suction type tension cut roller (S) was used and that a drive system (G) comprising a rubber belt and a rubber coupling was used for a mechanism which transmits power to the blade-driving unit; and “M+D” in the same means that a tension cut roller of mesh suction type (M) in which a porous metal was embedded in the sucking portions was used, and that a direct drive type blade-driving unit (D) which was directly connected to a motor without any mechanism for transmitting power thereto was used.

TABLE 1

| | | | Example No. | | | | | | |
|---|---|---|---|---|---|---|---|---|---|
| | | | 1 | 2 | 3 | 4 | 5 | 6 | 7 |
| Magnetic | Magnetic | Co/Fe (wt. %) | 25 | 25 | 25 | 25 | 25 | 21 | 25 |
| Layer | powder | Al/Fe (wt. %) | 6 | 6 | 6 | 6 | 6 | 6 | 3.5 |
| | | Y/Fe (wt. %) | 25 | 25 | 25 | 25 | 25 | 8 | 9.3 |
| | | Particle size (nm) | 45 | 45 | 45 | 45 | 45 | 45 | 100 |
| | Filler | Plate alumina (50 nm) | 10 | 10 | | | | | |
| | | Granular alumina (80 nm) | | 10 | 10 | 10 | | 10 | 10 |
| | | CB (75 nm) | | 2 | 2 | 2 | | 2 | 2 |
| | | Plate ITO (40 nm) | 5 | 5 | | | | | |
| Primer | Filler | Plate alumina (50 nm) | 40 | 40 | 40 | 70 | 40 | 40 | 40 |
| layer | | Needle iron oxide | | | | | | | |
| | | (100 nm) | | | | | | | |
| | | Granular alumina (80 nm) | | | | | | | |
| | | CB (25 nm) | | | | 30 | | | |
| | | Plate ITO (40 nm) | 60 | 60 | 60 | 60 | 60 | 60 | |
| BC layer | Filler | CB (25 nm) | 9 | 9 | 80 | 80 | 9 | 9 | 80 |
| | | CB (0.35 μm) | 1 | 1 | 10 | 10 | 1 | | 10 |
| | | Granular iron oxide | | | 10 | 10 | | | 10 |
| | | (0.4 μm) | | | | | | | |
| | | Plate iron oxide (50 nm) | 10 | 10 | 10 | 10 | | | |
| | | Plate ITO (40 nm) | 80 | 80 | 80 | 80 | | | |

| | | | | | | | |
|---|---|---|---|---|---|---|---|
| Thickness of magnetic layer (μm) | 0.06 | 0.06 | 0.06 | 0.06 | 0.06 | 0.06 | 0.06 |
| Thickness of primer layer (μm) | 0.6 | 0.6 | 0.6 | 0.6 | 0.6 | 0.6 | 0.6 |
| Thickness of support (μm) | 5.2 | 5.2 | 5.2 | 5.2 | 5.2 | 5.2 | 5.2 |
| Thickness of BC layer (μm) | 0.5 | 0.5 | 0.5 | 0.5 | 0.5 | 0.5 | 0.5 |
| Thickness in total (μm) | 6.36 | 6.36 | 6.36 | 6.36 | 6.36 | 6.36 | 6.36 |
| Slitting machine | M + D | M + D | M + D | M + D | S + G | M + D | M + D |
| Roughness Ra (nm) | 3.4 | 3.6 | 4.2 | 4.1 | 3.5 | 3.5 | 5.6 |
| Br/Bm | 0.84 | 0.84 | 0.84 | 0.84 | 0.84 | 0.83 | 0.85 |
| C (dB) | 2.1 | 2.0 | 1.8 | 1.9 | 2.0 | 2.0 | 0.4 |
| C/N (dB) | 5.9 | 5.9 | 5.4 | 5.6 | 5.8 | 5.9 | 0.9 |
| Thermal expansion coefficient (TD) | 2.7 | 3.5 | 5.0 | 5.0 | 2.7 | 3.5 | 5.0 |
| (×10⁻⁶/° C.) | | | | | | | |
| Humidity expansion coefficient (TD) | 7.9 | 8.7 | 9.8 | 9.8 | 7.9 | 8.7 | 10.2 |
| (×10⁻⁶/% RH) | | | | | | | |
| Amount of edge weave (μm) | 0.6 | 0.6 | 0.7 | 0.7 | 0.8 | 0.7 | 0.7 |
| Amount of off-track due to edge weave (μm) | 0.08 | 0.08 | 0.10 | 0.10 | 0.11 | 0.10 | 0.10 |
| Amount of off-track due to | 0.84 | 0.94 | 1.13 | 1.13 | 0.84 | 0.94 | 1.13 |
| thermal/humidity expansion (μm) | | | | | | | |
| Total amount of off-track (μm) | 0.93 | 1.02 | 1.23 | 1.23 | 0.95 | 1.04 | 1.23 |
| Decrease in output, using the same | 0.0 | 0.2 | 2.3 | 2.3 | 0.0 | 0.4 | 2.3 |
| apparatus (%) | | | | | | | |
| Decrease in output, using an apparatus | 14 | 15 | 17 | 17 | 15 | 15 | 17 |
| dislocated 1.5 μm from tracks | | | | | | | |
| Initial error rate (×10⁻⁷) | 0.2 | 0.2 | 0.4 | 0.4 | 0.2 | 0.4 | 3.8 |
| Error rate found after 100 times of tape | 0.2 | 0.3 | 0.5 | 0.4 | 0.2 | 2.6 | 3.8 |
| running (×10⁻⁷) | | | | | | | |

TABLE 2

| | | | Comparative Example No. | | |
|---|---|---|---|---|---|
| | | | 1 | 2 | 3 |
| Magnetic | Magnetic | Co/Fe (wt. %) | 25 | 25 | 25 |
| layer | powder | Al/Fe (wt. %) | 3.5 | 6 | 6 |
| | | Y/Fe (wt. %) | 9.3 | 25 | 25 |
| | | Particle size (nm) | 100 | 45 | 45 |
| | Filler | Plate alumina (50 nm) | | | |
| | | Granular alumina (80 nm) | 10 | 10 | 10 |
| | | CB (75 nm) | 2 | 2 | 2 |
| | | Plate ITO (40 nm) | | | |
| Primer | Filler | Plate alumina (50 nm) | | 70 | |
| layer | | | | (150 nm) | |
| | | Needle iron oxide (100 nm) | 60 | | 60 |
| | | Granular alumina (80 nm) | 10 | | 10 |
| | | CB (25 nm) | 30 | 30 | 30 |
| | | Plate ITO | | | |
| | | (40 nm) | | | |
| BC layer | Filler | CB (25 nm) | 80 | 80 | 80 |
| | | CB (0.35 μm) | 10 | 10 | 10 |
| | | Granular iron oxide | 10 | 10 | 10 |
| | | (0.4 μm) | | | |
| | | Plate iron oxide (50 nm) | | | |
| | | Plate ITO (40 nm) | | | |

| | | | |
|---|---|---|---|
| Thickness of magnetic layer (μm) | 0.06 | 0.06 | 0.06 |
| Thickness of primer layer (μm) | 0.6 | 0.6 | 0.6 |
| Thickness of support (μm) | 5.2 | 5.2 | 5.2 |
| Thickness of BC layer (μm) | 0.5 | 0.5 | 0.5 |
| Thickness in total (μm) | 6.36 | 6.36 | 6.36 |
| Slitting machine | S + G | S + G | S + G |
| Roughness Ra (nm) | 6.5 | 8.5 | 5.7 |
| Br/Bm | 0.84 | 0.82 | 0.79 |
| C (dB) | 0 | 0.5 | 1.5 |
| C/N (dB) | 0 | 3.1 | 4.7 |
| Thermal expansion coefficient (TD) | 16.3 | 5.0 | 16.3 |
| (×10⁻⁶/° C.) | | | |
| Humidity expansion coefficient (TD) | 21.4 | 9.8 | 21.4 |
| (×10⁻⁶/% RH) | | | |
| Amount of edge weave (μm) | 1.6 | 1.8 | 1.6 |
| Amount of off-track due to edge weave (μm) | 0.22 | 0.25 | 0.22 |
| Amount of off-track due to thermal/humidity | 2.53 | 1.13 | 2.53 |
| expansion (μm) | | | |
| Total amount of off-track (μm) | 2.75 | 1.38 | 2.75 |
| Decrease in output, using the same | 17.5 | 3.8 | 17.5 |
| apparatus (%) | | | |
| Decrease in output, using apparatus | 33 | 20 | 33 |
| dislocated 1.5 μm from tracks | | | |
| Initial error rate (×10⁻⁷) | 6.8 | 1.4 | 1.1 |
| Error rate found after 100 times of tape | 8.5 | 12 | 9.5 |
| running (×10⁻⁷) | | | |

Effect of the Invention

As is apparent from the results of Tables 1 and 2, as compared with the computer tapes of Comparative Examples 1 to 3, any of the computer tapes of Examples 1 to 6 of the present invention shows superior electromagnetic conversion characteristics, superior stability against changes in temperature and humidity and smaller amount of edge weave, and therefore, shows a smaller amount of off-track even when the temperature and the humidity change. The computer tape of Comparative Example 2 comprises the primer layer containing plate-like non-magnetic oxide particles with a particle size of 150 nm which goes beyond the scope of the present invention, and therefore, the surface roughness of the magnetic layer becomes larger, which results in poor electromagnetic conversion characteristics. The computer tape of Example 7 comprises the magnetic layer containing magnetic particles with a particle size of 100 nm which is larger than the particle sizes of 45 nm of the magnetic particles contained in the computer tapes of Examples 1 to 6, and thus shows inferior electromagnetic conversion characteristics. However, the computer tape of Example 7 comprises the primer layer containing plate-like non-magnetic particles with an average particle size of 10 to 100 nm, and therefore, shows a less decrease in output due to off-track as compared with the computer tapes of Comparative Examples 1 to 3. In addition, any of the computer tapes of Examples 1 to 7 shows a lower error rate after fed 100 times, as compared with the computer tapes of Comparative Examples 1 to 3.

1. A magnetic tape comprising a non-magnetic support, a primer layer containing non-magnetic powder formed on a surface of the non-magnetic support, a magnetic layer containing magnetic powder formed on the upper surface of the primer layer, and a backcoat layer containing non-magnetic powder formed on the other surface of the non-magnetic support, characterized in that
the magnetic powder comprises needle-like iron-based magnetic particles,
the thickness of the magnetic layer is 0.09 μm or less, and
the non-magnetic powder in the primer layer comprises plate-like non-magnetic oxide particles with an average particle size of 10 to 100 nm.

2. A magnetic tape according to claim 1, wherein the needle-like iron-based magnetic particles have an average major axis length of 20 to 60 nm.

3. A magnetic tape according to claim 2, wherein the needle-like iron-based magnetic particles comprise 20 to 40 wt. % of cobalt, 10 to 30 wt. % of at least one element selected from the group consisting of rare earth elements, and 3 to 10 wt. % of aluminum.

4. A magnetic tape according to claim 3, wherein the squareness ratio (Br/Bs) of the magnetic layer in the lengthwise direction is 0.80 or more.

5. A magnetic tape according to any one of claims 1 to 4, wherein the plate-like non-magnetic oxide particles are of at least one oxide selected from the group consisting of cerium oxide, zirconium oxide, aluminum oxide, silicon oxide and iron oxide.

6. A magnetic tape according to claim 1, wherein at least one of the primer layer and the backcoat layer contains plate-like conductive particles with an average particle size of 10 to 100 nm.

7. A magnetic tape according to claim 1, wherein servo signals for use in control of tracking are recorded on the magnetic layer or the backcoat layer.

8. A magnetic tape comprising a non-magnetic support, a primer layer containing non-magnetic powder formed on a surface of the non-magnetic support, a magnetic layer containing magnetic powder formed on the upper surface of the primer layer, and a backcoat layer containing non-magnetic powder formed on the other surface of the non-magnetic support, characterized in that
the magnetic powder comprises needle-like iron-based magnetic particles,
the thermal expansion coefficient of the magnetic layer in the tape widthwise direction is (0 to 8)×10⁻⁶/° C., and the humidity expansion coefficient of the magnetic layer in the tape widthwise direction is (0 to 10)×10^{-6/}% RH, and
the amount of edge weave which is formed on either of the edges of the tape serving as the side of reference for the feeding of the tape is 0.8 μm or less.

9. A magnetic tape according to claim 8, wherein the needle-like iron-based magnetic particles have an average major axis length of 20 to 60 nm.

10. A magnetic tape cartridge comprising a box-shaped casing body, and one reel of a magnetic tape as defined in claim 1, characterized in that the magnetic tape cartridge is tracked under the control of servo signals recorded on the magnetic tape.

11. A magnetic tape cartridge according to claim 10, wherein the servo signals are recorded as magnetic signals on the magnetic layer or the backcoat layer of the magnetic tape.

12. A magnetic tape cartridge according to claim 10, wherein the servo signals are recorded as optical signals on the backcoat layer of the magnetic tape.

13. A magnetic tape cartridge according to any one of claims 10 to 12, wherein the magnetically recorded signals on the magnetic tape are reproduced by a reproducing head comprising magnetoresistance elements.
